(19) United States
(12) Patent Application Publication
(10) Pub. No.: US 2015/0149287 A1
(43) Pub. Date: May 28, 2015

(54) RESPONDING TO AN ADVERTISEMENT USING A MOBILE COMPUTING DEVICE

(71) Applicants: Wendell BROWN, Henderson, NV (US); Evan Gregory Tann, Manitou Beach, MI (US)

(72) Inventors: Wendell BROWN, Henderson, NV (US); Evan Gregory Tann, Manitou Beach, MI (US)

(21) Appl. No.: 14/554,698

(22) Filed: Nov. 26, 2014

Related U.S. Application Data
(60) Provisional application No. 61/909,996, filed on Nov. 27, 2013.

(51) Int. Cl. G06Q 30/02

(52) U.S. Cl. CPC G06Q 30/0261; G06Q 30/0267
USPC 705/14.58

(57) ABSTRACT

A technique for selecting and presenting advertisement information is disclosed. The technique includes, in part, receiving a first set of data from a portable computing device. The first set of data corresponding to measurements performed by one or more sensors. The technique further includes, in part, determining a location of a portable computing device based at least on the first set of data, selecting a first set of output elements from a second set of data in accordance with the determined location and a third set of data of interest to a user, and sending at least one of the one or more elements to the portable computing device. The technique further includes presenting at least one of the one or more elements to a user of the portable computing device.

### CROSS-REFERENCE TO RELATED APPLICATIONS

This application claims benefit under 35 USC 119 (e) of U.S. Provisional Application No. 61/909,996, entitled “RESPONDING TO AN ADVERTISEMENT USING A MOBILE COMPUTING DEVICE,” filed Nov. 27, 2013, and incorporated herein by reference in its entirety.

### TECHNICAL FIELD

The present invention generally relates to presenting relevant information to a user, and more particularly to a method for generating a real-time stream of information associated with inputs from a portable computing device.

### BACKGROUND

An advertisement, hereinafter also referred to as an “ad,” is used to market and sell a product or service. Typical advertisements contain primary information in the form of text, images and/or audio information about a product or service. The primary information in the advertisement may also contain information, such as a toll-free 800 number, a website address, a physical street address, or another means of action, that provides a way for the viewer or listener to take an action to either buy the product or obtain more supplemental information related to the product. Magazine and video ads, roadside billboards, street-level ads, posters in the subway or bus stops, digital-out-of-home advertisements, kiosks, advertisements on vehicles such as taxis, buses, cars, and the like, contain similar information.

Online advertisement has increased significantly in recent years. The large amount of advertisements and/or feed information available to a user could be confusing and/or overwhelming. At the same time, size of available screens on portable computing devices has reduced (from laptops with relatively large screen sizes to smartphones and/or other wearable computing devices with relatively small screen sizes). There is a need in the art to use the available screen size and other output devices more efficiently to present information to a user and interact with the user.

### BRIEF DESCRIPTION OF THE DRAWINGS

An understanding of the nature and advantages of various embodiments may be realized by reference to the following figures. In the appended figures, similar components or features may have the same reference label.

FIG. 1 shows various blocks of an exemplary portable computing device, according to one embodiment of the present invention.

FIG. 2 shows an exemplary system including a portable computing device and a server, according to one embodiment of the present invention.

FIG. 3 shows an exemplary block diagram of a data generation system, according to one embodiment of the present invention.

FIG. 4 shows an exemplary system including a wearable computing device and a server, according to one embodiment of the present invention.

FIG. 5 shows an exemplary portable computing device sensing an advertisement, in accordance with one embodiment of the present invention.

FIG. 6 shows another exemplary system including a wearable computing device and a server, according to one embodiment of the present invention.

FIG. 7 shows an exemplary display of the portable computing device, in accordance with one embodiment of the present invention.

FIG. 8 shows exemplary operations that may be performed by a server, according to one embodiment of the present invention.

FIG. 9 shows exemplary operations that may be performed by a portable computing device, according to one embodiment of the present invention.

FIG. 10 shows another exemplary operations that may be performed by a portable computing device, according to one embodiment of the present invention.

FIG. 11 shows a simplified block diagram of a computer system that may incorporate embodiments of the present invention.

### SUMMARY

In one embodiment, a method for selecting advertisement information is disclosed. The method includes, in part, receiving a first set of data from a portable computing device. The first set of data corresponding to measurements performed by one or more sensors. The method further includes, in part, determining a location of a portable computing device based at least on the first set of data, selecting a first set of output elements from a second set of data in accordance with the determined location and a third set of data of interest to a user, and sending at least one of the one or more elements to the portable computing device.

In one embodiment, the method further includes, in part, ranking the first set of output elements to generate a ranked set of data, and sending one or more of highest ranked elements of the ranked set of data to the portable computing device. In one embodiment, the first set of output elements is ranked according to on one or more of an advertiser's fee rate, time since a user of the portable computing device was impacted by an advertisement, relevancy of an advertisement to interest of the user of the portable computing device.

In one embodiment, the method further includes, in part, obtaining information corresponding to locations of one or more advertising devices. The first set of output elements may then be selected based on a distance between the location of the portable computing device and at least one of the one or more advertising devices. In one embodiment, the information corresponding to locations of one or more advertising devices is retrieved from a database. In another embodiment, the information corresponding to locations of the one or more advertising devices is received from each of these devices.

In one embodiment, the method further includes, in part, estimating an upcoming location of at least one of the advertising devices, estimating an upcoming location of the portable computing device based at least on the first set of data, and selecting the first set of output elements based at least on the upcoming location of the at least one of the advertising devices and the upcoming location of the portable computing device. In one embodiment, the upcoming location of the at least one of the advertising devices is estimated based at least on information corresponding to a global positioning system (GPS).

In one embodiment, the first set of data includes, in part, location of the portable computing device, a speed of movement of the portable computing device, direction of movement of the portable computing device, and angle of view of an advertising device from the portable computing device. In one embodiment, the first set of output elements includes, in part, information corresponding to one or more of recently seen advertisement devices, one or more soon-to be seen advertisement devices, and one or more currently seen advertisement devices.

In one embodiment, a method for responding to advertisement information is disclosed. The method includes, in part, sending a first set of data from a portable computing device to a server. The first set of data corresponds to measurements performed by one or more sensors. The method further includes, in part, receiving a first set of elements from the server in response to the first set of data, presenting one or more elements from the first set of elements to a user of the portable computing device, and receiving at least one input corresponding to at least one selected element among the one or more elements.

In one embodiment, the method further includes, in part, sending a second set of data corresponding to user interests to the server. In one embodiment, the method further includes, in part, selecting the one or more elements from the first set of elements based on one or more criteria.

In one embodiment, the at least one input corresponds to at least one further action to be taken by the portable computing device. For example, the at least one action includes one or more of: requesting additional information corresponding to the selected element, requesting navigational information to a store corresponding to the advertiser, or any other action.

In one embodiment, presenting the one or more elements from the first set of elements further includes synchronizing a display of the portable computing device with a display of an advertising device corresponding to one of the one or more elements.

In one embodiment, the method further includes, in part, detecting one or more advertising devices using one or more sensors, and displaying information corresponding to the detected advertising device. The one or more sensors include one or more of optical sensors, infra-red sensors, wireless communications signal detector, and/or any other type of sensor.

In one embodiment, each of the one or more elements from the first set of elements is presented during a time frame in which the portable computing device is in proximity of an area corresponding to the element. The area corresponding to the element may include an area in vicinity of an advertising device, e.g., within a predetermined distance from the advertising device. In one embodiment, the area corresponds to an advertisement, an event, a billboard, a merchant location, a sale, and/or any other event associated with the element.

In one embodiment, one or more options corresponding to the one or more elements are presented to the user. The user may select one or more of the presented options. In one embodiment, the one or more elements are sent to a second device associated with the portable computing device. The second device may then present the one or more elements to the user.

In one embodiment, the first set of elements are ranked according to a relevance to a user of the portable computing device. In one embodiment, at least one of the one or more elements is stored in a database.

In one embodiment, an incentive may be presented/given to the user upon receiving the at least one input. The incentive may include a future discount, points, coupons, and any other type of incentive.

In one embodiment, a method for responding to advertisement information is disclosed. The method includes, in part, obtaining a first set of data corresponding to measurements performed by one or more sensors, determining a location of a portable computing device based at least on the first set of data, selecting a first set of output elements from a second set of data in accordance with the determined location and a third set of data of interest to a user, presenting one or more elements from the first set of elements to a user of the portable computing device, and receiving at least one input corresponding to at least one selected element among the one or more elements.

In one embodiment, an apparatus for selecting advertisement information is disclosed. The apparatus includes, in part, a memory, and at least one processor coupled to the memory. The at least one processor is configured, in part, to receive a first set of data from a portable computing device. The first set of data corresponds to measurements performed by one or more sensors. The processor is further configured to determine a location of a portable computing device based at least on the first set of data, select a first set of output elements from a second set of data in accordance with the determined location and a third set of data of interest to a user, and send at least one of the one or more elements to the portable computing device.

In one embodiment, an apparatus for responding to advertisement information is disclosed. The apparatus includes, in part, an output device, a memory, and at least one processor coupled to the memory and the output device. The at least one processor is configured, in part, to obtain a first set of data corresponding to measurements performed by one or more sensors, determine a location of the apparatus based at least on the first set of data, select a first set of output elements from a second set of data in accordance with the determined location and a third set of data of interest to a user, present one or more elements from the first set of elements to a user of the apparatus, and receive at least one input corresponding to at least one selected element among the one or more elements.

In one embodiment, an apparatus for responding to advertisement information is disclosed. The apparatus includes, in part, an output device, a memory, and at least one processor coupled to the memory and the output device. The at least one processor is configured to send a first set of data to a server. The first set of data corresponds to measurements performed by one or more sensors. The apparatus is further configured to receive a first set of elements from the server in response to the first set of data, present one or more elements from the first set of elements to a user of the apparatus, and receive at least one input corresponding to at least one selected element among the one or more elements.

In one embodiment, a non-transitory computer-readable medium is disclosed. The non-transitory computer-readable medium includes, in part, computer readable instructions configured to cause a processor to receive a first set of data from a portable computing device. The first set of data corresponds to measurements performed by one or more sensors. The computer readable instructions are further configured to cause the processor to determine a location of a portable computing device based at least on the first set of data, select a first set of output elements from a second set of data in accordance with the determined location and a third set of data of interest to a user, and send at least one of the one or more elements to the portable computing device.

In one embodiment, a non-transitory computer-readable medium is disclosed. The non-transitory computer-readable medium includes, in part, computer readable instructions configured to cause a processor to send a first set of data to a server. The first set of data correspond to measurements performed by one or more sensors. The computer readable instructions are further configured to cause the processor to receive a first set of elements from the server in response to the first set of data, present one or more elements from the first set of elements to a user of the portable computing device, and receive at least one input corresponding to at least one selected element among the one or more elements.

In one embodiment, a non-transitory computer-readable medium is disclosed. The non-transitory computer-readable medium includes, in part, computer readable instructions configured to cause a processor to obtain a first set of data corresponding to measurements performed by one or more sensors, determine a location of the portable computing device based at least on the first set of data, select a first set of output elements from a second set of data in accordance with the determined location and a third set of data of interest to a user, present one or more elements from the first set of elements to a user of the portable computing device, and receive at least one input corresponding to at least one selected element among the one or more elements.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims. The word “exemplary” is used herein to mean “serving as an example, instance, or illustration.” Any embodiment or design described herein as “exemplary” is not necessarily to be construed as preferred or advantageous over other embodiments or designs.

As used herein, the term “portable computing/communication device” or “mobile device” may be used interchangeably to refer to a computing/communication device that is portable and can be moved from one place to another. For example, a portable computing device may be a cellular telephone, cell-phone, smartphone, tablet, wireless communication device, laptop computer, mini-laptop, pad, mini-tablet, mini-pad, personal digital assistant (PDA), personal audio device (PAD), head-mount display (HMD), and/or other portable devices. The portable-computing device may include a processor and one or more sensors. A portable-computing device may further include one or more wearable-computing devices. A wearable-computing device may include any of an eyeglass, an ear-piece, a wristband, a wrist-device, a medallion, a device worn around the neck, an arm band, an arm-device, a device worn on the head such as a hat, a piece of clothing such as a shirt, a pair of pants, a scarf, and the like, a piece of outer clothing such as a coat, jacket, or the like, and any other wearable-computing devices, which include a processor and one or more sensors. Accordingly, a wearable-computing device is different from a laptop, which is not worn on a user's body.

Portable computing devices contain a variety of sensors and data input devices. Typical information, hereinafter also referred to as “data,” from portable-computing devices includes global positioning system (GPS) location information, wireless network status, mobile cell phone tower location, device acceleration, audio inputs, video inputs, fingerprint sensors, ambient light inputs, information about other devices associated or nearby the user's portable-computing device, e.g., tethered Bluetooth® devices, and/or the like.

A user of such portable-computing devices may be associated with various online social accounts or networks, such as Facebook, Twitter, LinkedIn and other similar accounts and/or networks. Online social account information may include a user's likes and dislikes, which may represent the user's interests. Some online social account information is fed or streamed to a user's portable-computing device as an information feed based on #hashtags, e.g., keywords that relate to the user's interests.

Embodiments of the present invention disclose a computer-implemented method for ranking information (e.g., advertisement information) in accordance with data measured by one or more environmental sensors. In one embodiment, the one or more sensors are associated with a portable computing device. The environmental sensors may capture a first set of data. The first set of data may include GPS signals, cell tower information and any other data. The portable computing device may then process the first set of data or send it to another device (e.g., a server) for further processing. The portable computing device and/or the server may determine a location of the portable computing device using the first set of data. The portable computing device and/or the server may then select a first set of output elements from a second set of data in accordance with the determined location and a third set of data corresponding to user interests. The second set of data may include information corresponding to one or more advertising devices, their locations, speed and/or direction of movement of the advertising devices, and any other information. The output elements may optionally be ranked by the portable computing device and/or the server before being presented to a user. The portable computing device presents some or all of the output elements to a user. The portable computing device may then receive at least one input from the user corresponding to an element of interest to the user (e.g., request for additional information corresponding to an advertisement, location of nearest store corresponding to the advertisement, and the like).

In one embodiment, information from a multitude of sources may be correlated, filtered, selected and/or ranked according to a user's interests and/or current environment, in real-time. The information from the multitude of sources may include real-time data inputs and/or non-real-time data inputs. Real-time input may refer to an input, such as a sensor reading, corresponding to an event at the actual time that the event happens. In addition, processing an input in “real-time” refers to a substantially small amount of delay between receiving an input by a device, and processing the input and generating a corresponding output.

In one embodiment, the ranked information, such as advertisements, feeds, tweets and/or the like, may be output on a portable-computing device in real-time. The user is thus presented with more useful or relevant real-time output data than currently possible with existing internet search techniques that, in-contrast, input and output static web pages that may not be current or even active, nor take into consideration the user's environment in real-time. In one embodiment, the user's interests are declared interests, such as through active or passive feedback from the user. In another embodiment, the user's interests may be predicted or anticipated automatically. In one embodiment, the information from the multitude of sources may be streamed information. In another embodiment, the information from the multitude of sources may not be streamed information. In one embodiment, the output data may be streamed information. In another embodiment, the output data may not be streamed information.

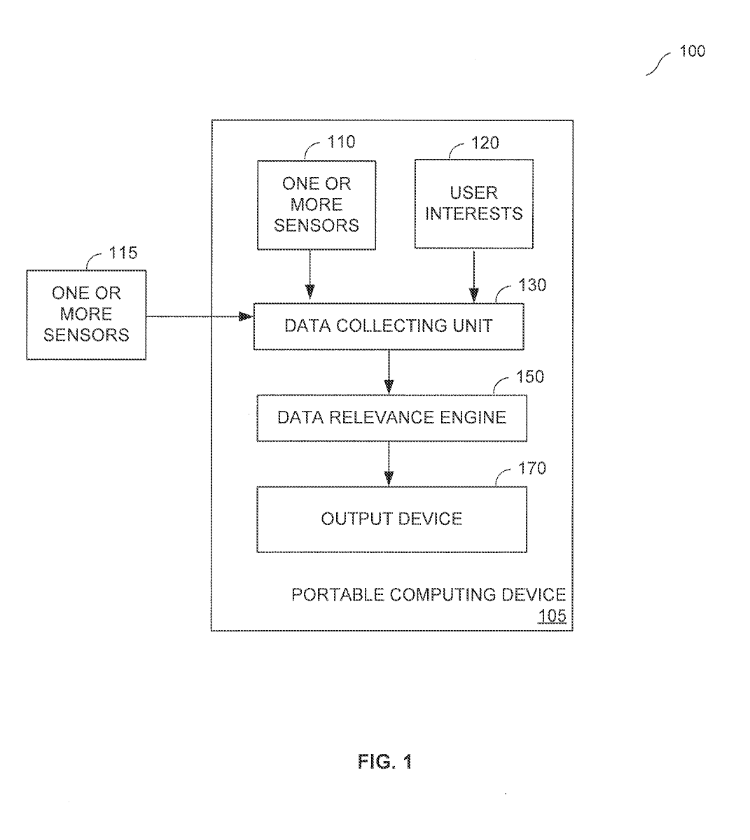

FIG. 1 shows various blocks of an exemplary portable computing device, according to one embodiment of the present invention. As illustrated, the portable computing device 100 receives data corresponding to measurements from one or more sensors 110, 115. The portable computing device in real-time senses primary information about the environment in the local vicinity, line-of-sight, and/or hearing distance adjacent the portable computing device via the one or more sensors associated with the portable-computing device. Primary information may refer to the information that can be directly sensed from the local environment in real-time, such as an advertisement that is sensed by visual, audio, or electronic means by the portable-computing device or the user. Further, primary information may be data requested by the user through the portable-computing device such as a feed, tweet, web page, e-mail, or the like. The sensors on the portable computing device sense primary information, hereinafter also referred to as an “environmental signal,” such as location information (e.g., GPS or cellular system location), altimeter elevation, device acceleration, motion, audio, video, fingerprint, heart rate, breathing rate, retina scan, and/or other biometric information, ambient light, near-field communication, wireless network status, infrared, ultrasonic, gyroscopic, orientation, and/or the like.

In general, the portable-computing device may include a multitude of such sensors to sense information associated with the user's environment in real-time. Further, a sensor may be associated with the portable-computing device through another portable device or second portable-computing device that is different than but tethered wirelessly or by wire to a first portable-computing device in various combinations. In other words, a sensor need not be on the user's first portable-computing device but may be associated with the user's first portable-computing device. For example, an audio microphone may be located on an earpiece wirelessly connected to a first portable-computing device, such as a smart-phone having a video camera sensor. A bicycle speedometer type portable-computing device on a bicycle may be further added to the first portable-computing device's sensor network.

In addition, the portable computing device collects information corresponding to interests 120 of a user. The information may be collected and stored in a data-collecting unit 130. The data-collecting unit sends the collected information to the data relevance engine 150 for processing. The data relevance engine processes the received information and selects a set of relevant information to output on the output device 170.

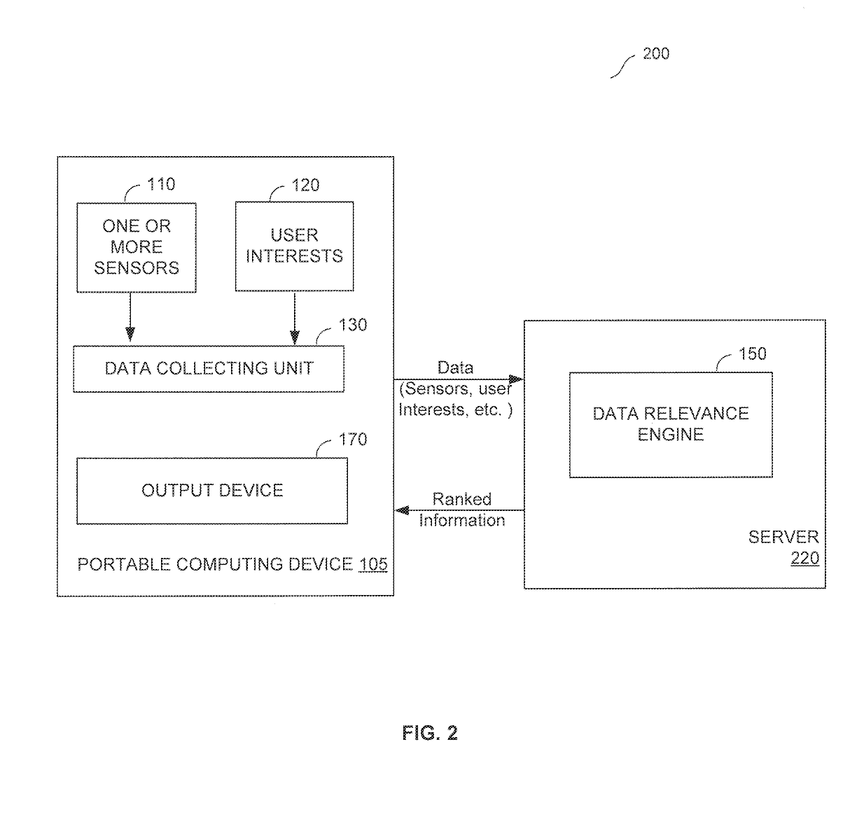

In one embodiment, as illustrated in FIG. 1, the data relevance engine is part of the portable computing device. In another embodiment, the data relevance engine is located in a server (as illustrated in FIG. 2), which receives information from the portable computing device.

FIG. 2 shows an exemplary system including a portable computing device and a server, according to one embodiment of the present invention. The portable computing device 105 collects information from the sensors and/or user interests and sends them to the server. The server 220 processes the received information and ranks its available information based on their correlation with user interest and/or received sensor measurements. The server sends some information to the user that has the highest relevance with user interests and/or the current environment/location of the user.

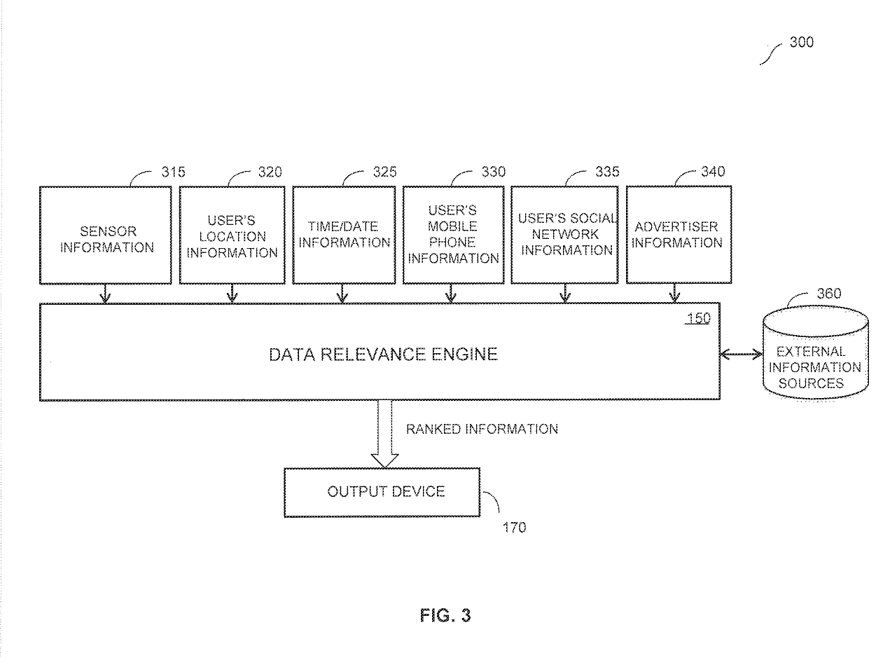

FIG. 3 shows an exemplary block diagram of a system for responding to an environmental signal, according to one embodiment of the present invention. As illustrated, a multitude of information inputs, each from a different one of a multitude of sensors are sent to the data relevance engine in real-time as an information stream. Any number of sensors may be tethered in a local network to provide data of interest associated with the user's environment or where the user is located, such as on a bicycle, automobile, plane, or other transportation vehicle. Accordingly, sensors are not associated with keyboard keys or keyboard icons, nor are real time sensor data the same as data that is input via keyboard keys or keyboard icons. In one embodiment, data from a user's portable-computing device's body motion sensors are used to correlate and weight data inputs. In one embodiment, data from a user's wearable-computing device, which indicates the user's location, such as GPS information, cell phone tower, and/or the like, is used to gather, correlate, weight and then rank the output data.

The sensor information 315 is sent from the portable-computing device to a data relevance engine 150 via cable, wireless radio, infrared, internet network link, or any other method. In one embodiment, data from one or more real-time sensors is passively collected, e.g., an audio or video sensor data may be continuously transmitted in real-time, for a predetermined period of time. The user may choose the predetermined period of time via controls in the portable-computing device. In one embodiment, primary sensor information is transmitted upon request or demand, or upon a timed predetermined sequence. In one embodiment, primary sensor information 315 is transmitted continuously in time as an information stream, the sensor information following the changes in the environment as the user moves through that environment, not only as geographic location changes but further including changes in the users orientation, such as what the user's wearable-computing device may be seeing or hearing in real time.

In one embodiment, the data relevance engine is a computing device located in the internet cloud, which may provide a critical advantage of not adding additional computational or data storage burdens on the portable-computing device, increasing battery life and/or performance of the portable-computing device. In another embodiment, the data relevance engine is located in the portable-computing device (as illustrated in FIG. 1). In one embodiment, one portion of the data relevance engine is located in the internet cloud, while another portion of the data relevance engine is located in the portable-computing device. In one embodiment, the relevance engine performs calculations in one or more computing devices “in the cloud,” with such computing devices connected to a user's portable, mobile, or wearable-computing-device via a wireless connection, such as a WiFi®, mobile data network, Bluetooth®, or similar networks, or via a wired connection, such as Ethernet.

In one embodiment, the primary information is transmitted from the portable-computing device to the data relevance engine directly. In another embodiment, the primary information is transmitted from the portable-computing device to the data relevance engine indirectly, e.g., from a second device tethered to the portable-computing device, such as a wearable device associated with a smart phone.

In one embodiment, the primary information may include global positioning system (GPS) and/or cellular network positioning location information 320 corresponding to the portable-computing device. In one embodiment, the portable computing device may be associated with a wearable computing device (e.g., a mobile phone associated with a head-mount display). The wearable computing device may also be able to receive GPS signals. The GPS and/or cellular location information may be transmitted from the portable-computing device and/or the wearable computing device (e.g., directly or indirectly) to the data relevance engine periodically or in real time. The portable-computing device may be in motion and its position transmitted provides current location, speed and/or direction of movement-information that may be used by the system to predict likely future location.

In one embodiment, the primary information may include time and/or date information 325 for the portable-computing device. The time and/or date information may be transmitted from the portable-computing device to the data relevance engine. In another embodiment, the time and/or date information is available to the data relevance engine, which then correlates or time and/or date stamps the received primary information accordingly.

In one embodiment, the primary information may include information associated with the portable-computing device 330, such as contacts, prior, e.g., historical location data of the device, email addresses, account, serial, identification, model, firmware, web address, stored photo or video, historical browser information such as prior purchases and/or payments, and/or the like. The information associated with the portable-computing device may be transmitted from the portable-computing device to the data relevance engine.

In this document, the terms “secondary information” or “supplemental information” are used to refer to information that is not primary information. In one embodiment, secondary information may be associated with a user interest from the user's social network in the cloud, such as likes, dislikes, social graphs, social graph elements, friends, thumbs up, thumbs down, email addresses, stored photo or video, product or service reviews, #hashtags, tweets and/or the like. The information associated with the user's social network, such as Facebook, may be store on the device or be received 335 from the cloud.

In one embodiment, the user is associated with the portable-computing device (e.g., the owner of a portable computing device). In another embodiment, the user may not be associated with the portable-computing device. For example, the user may be a social network friend of or someone who recommends the user who is associated with the portable-computing device. In this case, the data may include recommendations, preferences, or interests of a user who is not associated with the portable-computing device but is still associated through the social network with the user who is associated with the portable-computing device. Thereby, the data relevance engine may have access to a multitude of user interest data from users who may share similar interests as the user associated with the portable-computing device. In one embodiment, other sensors in the user's nearby location, such as sensors associated with other nearby users, fixed sensors, and/or the like may be used as primary real-time inputs. In one embodiment, data in a user's social graph, for example such as the Facebook social graph, or other similar user data, such as the user's friends or friend's likes, are used to correlate and weight data inputs.

In one embodiment, advertiser information and/or information associated with advertising devices 340 may be used by the data relevance engine. This information may be received from each advertising device or an advertiser. The server may store information corresponding to each of the advertisers and their associated advertising devices. The server may use this information and/or send portions of it to a portable computing device. In one embodiment, the information associated with advertisers may include a geographic location of one or more advertising devices, orientation, viewing angles, direction or heading for viewing the ad, contents, time of presentation, and/or the like for one or more advertisements that are presented on each advertising device. In one embodiment, an advertisement may be static in the form of fixed media such as paper, magazines, billboards, and the like. In addition, the advertisement may be presented by static electronic media such as LED signs. In another embodiment, an advertisement may be presented dynamically on an active display, such as electronic media including signs with physically changing structure, such as a rolling sign, capable of displaying different advertisements at different times at the same geographic location. For example, a billboard in a stationary location may be an active display that changes between a multitude of advertisements from time to time or periodically, with known predetermined display times for a particular advertisement. In another example, the billboard's display surface may be oriented substantially perpendicular to a direction of an adjacent road so as to be seen primarily from the direction of approaching traffic along the road, that traffic including a user wearing or carrying the portable computing device.

In one embodiment, the advertisement may be displayed on a moving object such as in a bus, subway car, taxi, blimp and the like and the real time velocity, speed, expected position, and/or expected position in time of the advertisement may be calculated or determined via GPS and/or cellular phone tower, or other location determination means, and be transmitted to the server. In another embodiment, the advertisement may be in any combination of static, dynamic, stationary or moving type advertisement with associated information received by the server. For example, a dynamic LED sign that periodically changes between different advertisements on a roof of a moving taxi. In one embodiment, the information associated with the advertisements may be stored in a database or similar data storage directly or indirectly accessible to the data relevance engine. Such advertisement information may be correlated by the data relevance engine with information sensed by the portable electronic device to determine advertisement ranking to present advertisement information and/or interaction options associated with the advertisement to the portable electronic device that are of immediate relevance to the user as will be described below.

In one embodiment, primary and/or secondary information may be associated with external information sources 360, which are linked and/or accessed by the data relevance engine. External information sources may include any kind of information source, data base or service that may push, feed, transmit, or be accessible as information to the portable-computing device not included in the information input embodiments already described above. Examples of external information sources include stock movements, social media posts, sports updates, Yelp, Groupon, broadcasting networks, such as NBC Sports or National Public Radio, financial information services, email services, text messaging services, geographical map database services, weather reporting and/or prediction, historical information such as purchase, payment, or credit history, other websites and/or the like.

In one embodiment, the portable computing device may cache, pre-cache, look-ahead cache, predictive cache, local area cache, or other form of look ahead caching/fetching to efficiently, and/or quickly retrieve one or more elements of information. In one embodiment, a real-time database may be used to store and house the information. Information about the user, that may eventually be sent to the merchant/advertiser, may be fetched from a pre-stored location either on the portable computing device or from another location, e.g., stored in the cloud and/or stored in a user's account and/or preferences settings.

In one embodiment, primary and/or secondary data may be correlated 150 in real-time by the data relevance engine to determine the resulting information in a ranked order associated with the correlated data. In other words, the data relevance engine correlates the primary information or environmental signals, e.g., from the real-time sensors on the portable-computing device, with secondary information, e.g., data from social media networks, associated with a user interest, data associated with advertisers, and the like to form a correlated data. The data relevance engine then determines a resulting information as an output. The resulting information includes real-time information in a ranked order, or unranked information that has been filtered to keep information that is of interest to the user.

In one embodiment, the data relevance engine correlates the primary information or environmental signals, e.g. from the real-time sensors on the portable-computing device, with information associated with at least one advertisement in addition to or in any combination with the information sources described above, to form the correlated data and determine at least one relevant advertisement. The resulting information may include real-time information of advertisements in a ranked order of relevance to the user. The ranked advertisement order is associated with the correlated data. For example, an advertisement may be deemed by the system to be a relevant advertisement when the advertisement is in good current viewing distance and orientation relative the user's portable-computing device position because it may be given a higher weighted ranking than an advertisement that is located farther away. In one embodiment, resulting information determined by the data relevance engine may include one or more interaction options associated with the at least one relevant ad. In one embodiment, the system may inform or present that an advertisement of real-time interest is available to the user, via the portable computing device. In one embodiment, the real-time interest may be in accordance with the user's prior historical information, social graph, Likes, other inputs from the user or user's friends, and/or the like.

In one embodiment, the ranked order is associated with the user's interests and/or location in addition to the advertising device's location. As location of the portable computing device and/or the advertising device changes, the output elements presented to the user may be updated. In one embodiment, the output elements may be streamed continuously, periodically, or at predetermined times.

In one embodiment, the data relevance engine makes its determination of the rank order automatically, without active user input, using passively collected data from primary and/or secondary data inputs that are associated with the user's interests and/or location information. In another embodiment, the data relevance engine makes its determination of the rank order semi-automatically, with some active user input during a learning period for the data relevance engine or during occasional subsequent times when the user wants the output of the data relevance engine to be adjusted or changed, for example when the user's interest changes.

The resulting information and ranked order may be sent from the data relevance engine to the portable-computing device, where the ranked resulting information may be available to the user's senses. The ranked resulting information may be visually, audibly, or tactilely available to the user via the output device 170. In one embodiment, the resulting information may be presented such that the predicted most relevant data (e.g., advertisement) is presented first or in a form of higher visibility than less interesting data. In other embodiments, the resulting information output may be included as a standalone application or may alternatively be included in a portion of another application, e.g., a monetization/embedded stream within another application. In one embodiment, a portable-computing device's detected motion sensor information may be used to change/update/scroll/move the contents of the displayed resulting information.

In one embodiment, a multitude of advertisements that are relevant/related in real-time to the primary and/or secondary data inputs and thus selected to match the user's real-time interests may be presented to the user. In one embodiment, at least one advertisement, which is deemed to relate in real-time to at least one of the data input sources, may be presented to the user in the output data stream (e.g., ranked information). In one embodiment, at least one merchant offer, for example such as a local daily deal, which may be deemed to relate to at least one of the data input sources, may be included in the output data stream.

In one embodiment, the resulting information may include an actionable link and/or one or more interaction options associated with at least one relevant advertisement. For example, the actionable link may direct the user's browser to a website that may initiate a purchase of a service or product. In another embodiment, the user may request navigation information for the nearest store associate with an advertisement.

In one embodiment, a portion of the resulting information may be continuously updated in real-time. In another embodiment, a portion of the resulting information may be updated at a predetermined time when the data relevance engine determines the resulting information should be updated due to a change in one of the multitude of information inputs. In one embodiment, the resulting information may be updated periodically. In one embodiment, the ranking of the resulting information may be updated dynamically at predetermined times when the data relevance engine determines a new ranking order is appropriate due to changes in one of the multitude of information inputs.

In one embodiment, the resulting information output may be presented to the user such that the ranking value of most relevant or interesting resulting information is more easily consumed or understood by the user than the lower ranked, less interesting resulting information. In one embodiment, the resulting information may be presented visually as a list of information ranked in order from most interesting information presented first, such as at the top of a list, and the less interesting resulting information presented in sequence of a rank value, such as from top to bottom of the list with the least interesting information presented at the bottom of the list.

In another embodiment, the resulting information may be presented as audio output, such as an audio announcement presenting the most interesting resulting information first in sequence of a rank value. Less interesting information may be presented after the most important resulting information presented in sequence of a rank value, such as from first to last in the sequence with the least interesting information presented at the end of the sequence.

In one embodiment, the resulting information may be presented in a repeating sequence. In one embodiment, the repeating sequence of the resulting information may repeat the resulting information that has higher rank order at greater frequency than the less interesting resulting information with lower rank order. In one embodiment, the resulting information may be presented at a time associated with the ranking value.

In one embodiment, the resulting information may be presented in a format associated with the ranking value. In one embodiment, the format of the resulting information that has higher rank order may be presented to draw greater attention than the less interesting resulting information with lower rank order. For example, resulting information that has higher rank order may be presented in bolder, larger, flashing frequency, and/or colored font associated with the ranking value for a visual display, or by type of voice and/or volume for an audio display.

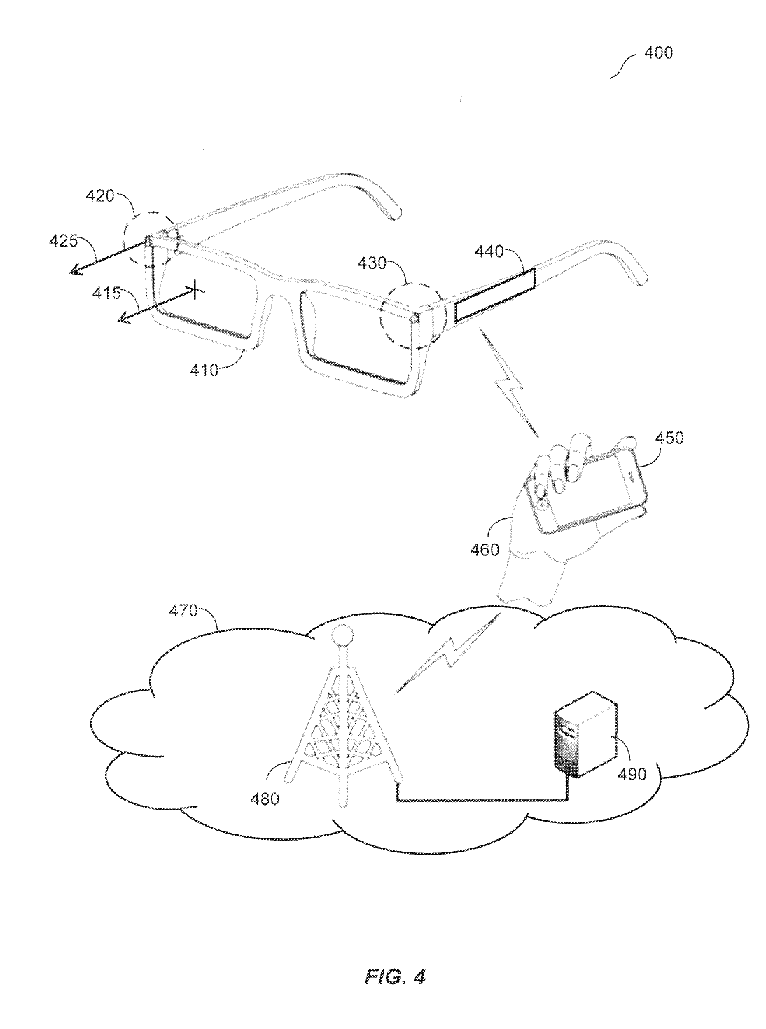

FIG. 4 shows an exemplary system including a wearable computing device and a server, according to one embodiment of the present invention. In this example, wearable-computing device 410 includes a form factor for eyewear with one or more displays and may include a sensor such as a camera 420, and/or a microphone 430. Camera 420 may include a video and/or a still camera or multiple cameras and one or more optical axis 425 oriented such that the video camera's field of view is aligned with the line of sight of the user 415. In other words, camera 420 may see the same image the user sees through the eyewear of wearable-computing device 410. In one embodiment, the sensor may be on continuously or periodically over a predetermined period of time seeing or hearing whatever the user sees and hears in the vicinity of the user.

Wearable-computing device 410 may further include an electronic circuit 440. Electronic circuit 440 may in-turn include one or more inputs such as a touch sensor or button, a processor, a data storage, and a battery. In one embodiment, electronic circuit 440 may include a wireless radio transceiver. In one embodiment, the wireless radio transceiver may operate on low bandwidth, power saving radio transmission standards such as Bluetooth®, 6LoWPAN®, ZigBee®, DASH7®, Z-Wave®, MiWi®, or OSION®. In another embodiment, the wireless radio transceiver may operate in accordance with WiFi®, or cellular radio transmission standards. The wearable-computing device 410 may be able to project images received by electronic circuit 440 to the user wearing wearable-computing device 410 through the lenses of the eyewear such that the projected image is seen by the user superimposed over the real image as viewed by the user. Therefore, the resulting information transmitted from the data relevance engine may be visually displayed in the user's field of view on wearable-computing device 410.

In one embodiment, electronic circuit 440 may further include an audio output device, such as a speaker or bone transducer. Therefore, the resulting information transmitted from the data relevance engine may be audibly played to the user via the audio output device on wearable-computing device 410. In one embodiment, electronic circuit 440 may further include GPS, cellular location, and/or orientation circuitry, which may respectively determine the location and/or height on the earth and the orientation at that location of wearable-computing device 410. In other words, orientation circuitry may provide to wearable-computing device 410 the direction video camera 420 and the user are viewing, for example, compass or azimuth and altitude angles relative to the user. In one embodiment, electronic circuit 440 may further include a gravitational sensor and/or an accelerometer, which may provide a velocity information and/or an acceleration information for wearable-computing device 410.

A portable-computing device 450 is wirelessly tethered to the wearable-computing device 410. In this example, the portable-computing device 450 is a smart phone, however, portable-computing device 450 may be any other portable computing device such as a laptop, mini laptop, tablet, or pad, which may or may not include a wireless radio transceiver that may link or tether portable-computing device 450 to wearable-computing device 400 on user 460. In one embodiment, portable-computing device 450 may be tethered to wearable-computing device 410 via a wire and a wired communication system connecting wearable-computing device 410 to portable-computing device 450. In one embodiment, location, orientation, gravimetric and/or acceleration sensors may be included in portable-computing device 450 or distributed between wearable-computing device 410 and portable-computing device 450 in any combination. Portable-computing device 450 may further include a cellular radio transceiver or WiFi® radio transceiver that may link portable-computing device 450 to the world-wide-web or cloud network 470.

Portable-computing device 450 may further include a display. In one embodiment, the data relevance engine may send a first portion of the resulting information, e.g. ranked or unranked resulting information output, indicator, logo, ad, and/or the like, to wearable computing device 410, and the remaining portion in any combination to portable-computing device 450. In one embodiment, a first portion of the resulting information is presented on wearable computing device 210 and the remaining portion in any combination is presented on portable-computing device 250.

A world-wide-web or cloud network 470 may be linked to wearable-computing device. A base station 480 sends or receives cellular or WiFi® radio transmission to or from portable-computing device 450, respectively. Base station 480 may be coupled to one or more server 490 computing devices. In one embodiment, a multitude of servers may be located in different locations or in multiple clouds. In another embodiment, wearable-computing device 410 may include a cellular radio transceiver or WiFi® radio transceiver directly providing the link to the world-wide-web or cloud network without portable-computing device 450 serving as the intermediary communications link.

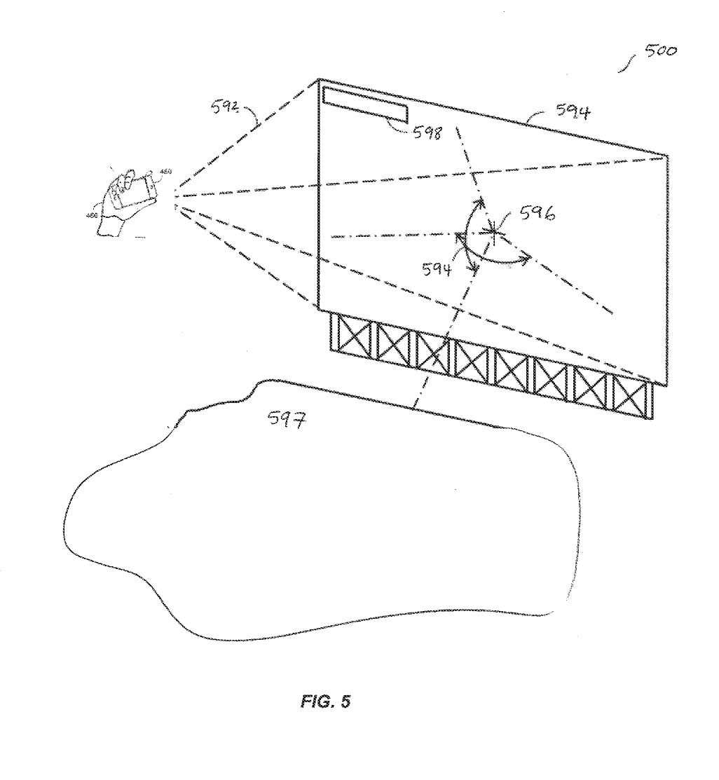

FIG. 5 illustrates an exemplary portable computing device 450 that senses, represented by dashed lines 592, an advertisement 594, in accordance with one embodiment of the present invention. The advertisement information stored in a database may include viewing angles, direction or heading where the advertisement may be viewed 596, represented by dashed and dotted lines and geographic location 596 of the advertisement in relation to a path or road 597 that a user may be located on. In one embodiment, when the location information of the user and the orientation information from wearable-computing device 410 are in the primary information, the location and orientation information and, optionally, the camera or microphone sensor's real partial input, may be correlated with the advertisement information to predict a probable advertisement the user is likely viewing, and/or hearing, and/or generate a list of related advertisements for future display. Data associated with the advertisement may then be transmitted to wearable-computing device 410 and/or portable computing device 450.

In one embodiment, the wearable-computing device 410 or portable computing device 450 may re-create the advertisement for the user or create a simulated view, e.g., a virtual view, or sound to be seen/heard by the user of the probable advertisement the user should be seeing or hearing. In one embodiment, primary or supplemental information may be modified by time of day, day of the week, user's preferences, user's detected preferences, user's prior activities, or other similar information or variables. In one embodiment, a video or camera sensor is sensed for any possible text input or advertisement identification code 598 located in the advertisement, the text or code of which is then fed into the data relevance engine input. In one embodiment, a viewer's wearable computing device could further detect the advertisement by means of optical sensors, via a camera, infra-red, Bluetooth, Wi-Fi or near-field or other wireless communication means, and/or the like.

In one embodiment, location data of wearable-computing device 410 that is in motion may be correlated with environmental signal data from its sensors to determine a probable future location of wearable-computing device 410 in order to proactively determine resulting information before the wearable-computing device 410 reaches an advertisement's or an event's location. In one embodiment, a hash table approach or similar proximity detection algorithm or other sorting/distance-related method is used to match a real-time sensor information from the portable computing device to potential “matched” advertisements or activity venues. When a sensor's field of view, or potential field of view, matches or is within or near the viewing angle of the advertisement or activity venue then a “match” is found, the portable computing device and user associated with the sensor may be alerted or otherwise notified. In one embodiment, a user's “matches” may be stored in the portable computing device and/or in the cloud (in the user's account) to enable to user “history” of matches be displayed for review and for auditing and/or analytics purposes.

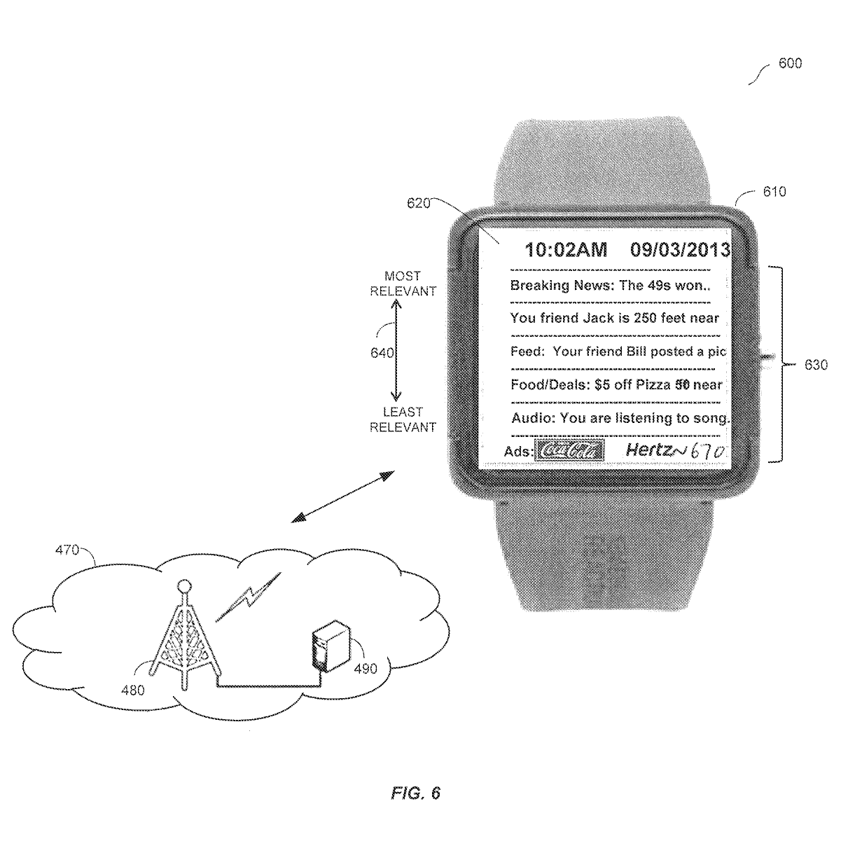

FIG. 6 shows another exemplary system including a wearable computing device and a server, according to one embodiment of the present invention. The wearable-computing device 610 includes an exemplary visual display output 620. In this example, wearable-computing device 610 includes a form factor for a wristwatch, wristband, smart-watch, or the like, with one or more displays. Wearable-computing device 610 may include some of the same features as described in reference to the wearable-computing device 410 with the exception that visual display output 620 is not transparent so as to be worn over the eyes but is instead worn on the user's wrist.

Visual display output 620 may include a time/date display as would be expected for a watch, and a ranked resulting information display area 630. Ranked resulting information display area 630 includes a multitude of display lines that can be used to present information and/or advertisement to the user. Each display line may be associated with a different one of a multitude of information types. The multitude of display lines is ranked in a list with the most relevant displayed at the top and the least relevant at the bottom as shown by graph 640.

In one embodiment, one or more of the multitude of display lines in the list may stream continuously updating the resulting information. In one embodiment, one of the multitude of display lines may statically display the resulting information until a predetermined time when the data relevance engine determines the resulting information should be updated due to changes in the information inputs. In one embodiment one of the multitude of display lines may be updated periodically with new information. In one embodiment the ranking of the multitude of display lines may be updated dynamically at predetermined times when the data relevance engine determines a new ranking order is appropriate due to changes in the information inputs.

In this example, the top line of ranked resulting information display area 630 includes a breaking news feed text line that the 49ers football team won. The news the 49ers won may have been selected by the data relevance engine as most relevant based on, for example, multiple signals from the user's social network that the user is interested in the 49ers, and importantly, that wearable-computing device 610 is not presently at the stadium where the 49ers were playing. If wearable-computing device 610 were at the stadium where the 49ers were playing, the user would have already known of their win and the data relevance engine would have considered that information not relevant to display. Thus, the ranking criteria were dynamically analyzed in real time by the data relevance engine using the sensor data on wearable-computing device 610, e.g., GPS location. In one embodiment, other information such as geographical map database, historical information of prior attendance at 49ers games, and/or football team schedules may be included in the analysis by the data relevance engine.

Referring back to FIG. 6, the next line down of ranked resulting information display area 630 includes a text line that the user's friend Jack is 250 feet near, which was captured by the data relevance engine because Jack is also a user of the same data relevance engine, or captured via social network information. Similarly, the next line down of ranked resulting information display area 630 includes a text line that the user's friend Bill posted a picture of relevance on a social network site. The next line down of ranked resulting information display area 630 includes a text line for a discounted food deal for Pizza, determined in one example, because the user's social network site information indicates a liking for Pizza, there is a Pizza restaurant 50 feet from the wearable-computing device 610, and that several of the user's friends have liked the pizza at this nearby restaurant. The next line down of ranked resulting information display area 630 includes a text line for what song is currently being played through wearable-computing device 610 via headphones or other manner.

Display area 630 includes one or more lines for product or service advertisements that have been selected by the data relevance engine. These advertisements may be more meaningful than those selected by previous methods because the primary information from the wearable-computing device 610 provides current geographical location and current user interests in real-time. For example, the wearable-computing device 610 may be at an airport destination, where a car rental need is likely so an icon for a car rental company advertisement 670 may be displayed and there is a soft drink dispensing machine nearby so a soft drink advertisement is displayed. In one embodiment, the audio sensor in wearable-computing device 610 may have picked up the spoken word “thirsty,” which was analyzed in real time by the data relevance engine to rank and select the advertisement category of soft drinks to display.

A world-wide-web or cloud network 470 may be linked to the wearable-computing device 610 represented in FIG. 6. In this example, the wearable-computing device 610 is shown directly communicating with the internet cloud 470, without the need for another intermediary portable-computing device to be tethered nearby.

In one embodiment, a portable computing device 450 provides a method and apparatus for responding to the relevant advertisement by means of touching, gesturing, speaking, moving, or otherwise reacting in relation to portable computing device via sensors therein. In one embodiment, one of the multitude of display lines 630 may include an actionable link and/or one or more interaction options associated with the at least one relevant advertisement or item on the ranked list. In one embodiment, visual display output 620 may display a list of advertisements (e.g., ranked or unranked) that the user may select for further action. For example, visual display output 620 may include a touch sensitive display screen adapted such that the user may select and request additional secondary information associated with the car rental company advertisement be sent by the system to portable computing device 610 by touching the icon for the car rental company advertisement 670.

In one embodiment, a viewer may provide an input to the portable computing device, e.g., trigger an action, by pressing a button on a wearable and/or portable computing device, performing a body gesture, speaking a voice or sound command, touching a portable computing-device, and/or looking or gazing at an object, such as an advertisement or activity venue. In one embodiment, one button may awaken the portable computing-device and confirm to the user which advertisement the user wished to respond to, then additional inputs (e.g., or key presses/touches/sound command inputs) on the device may select additional response options or alternate advertisements to select and respond to. In one embodiment, multiple levels of nested interactive option menus may be used by the system to navigate complex option decisions. In one embodiment, a user may gesture, for example, wave their hand over the wearable device, or shake the device, or the user may raise his hand or move another body part, e.g., head, in order to trigger the response/reaction to the interactive option.

In one embodiment, a notification, such as a logo bug, a symbol, and/or the like, may be displayed on the portable computing device, for a predetermined period of time near the time when the portable computing device and associated user are in proximity to a predetermined area defined by an advertisement, an event, a billboard, a merchant location, a sale, a Groupon or similar coupon, a person or friend, and/or the like. The notification may signal to the portable computing device that further information may be available, which then may signal to the portable computing device that additional options or information are available. The user may then indicate, via a press, a gesture, a voice, a sound input, a touch, or any other form of human-to-device notification, that the portable computing device and associated user requests to see further information, select options, respond to that event or advertisement, or otherwise respond to the event that the portable computing device was notified of.

In one embodiment, the portable computing device may display information such as a brand name, a tagline, a graphical logo, a sound, a voice output description, a light/LED display blink or other light-based indicator, or other means of indication/alert or information, to let the user know that further information is now available. In one embodiment, items are shown which may not be associated to nearby events/merchants/advertisements, but are presented/displayed/alerted to the portable computing device and user from time-to-time. For example, some alerts/notifications may be sent according to time, user's interests, friends' locations, and the like.

In one embodiment, a first portable computing device, such as smart glasses may indicate or alert the user that interactive options or actions are available, but the user may press/select/interact with another associated second portable computing device, such as a mobile phone. In other words the portable computing device that indicates or presents the interactive option to the user, may be a different portable computing device than the user responds with. In another embodiment, the portable computing device that indicates or presents the interactive option to the user, may be the same portable computing device than the user responds with.

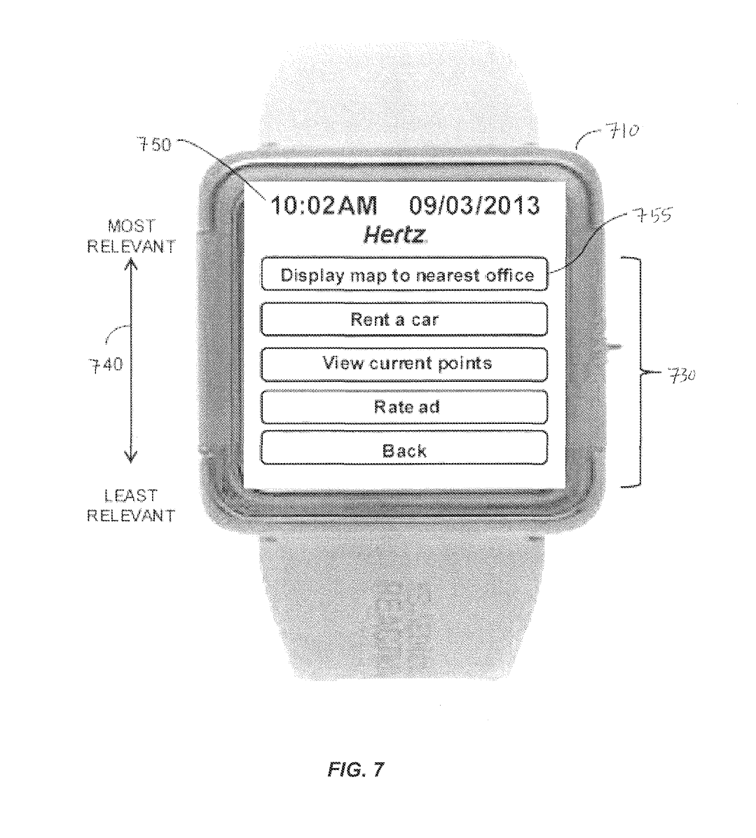

FIG. 7 depicts a simplified perspective view of a wearable-computing device 710 with an exemplary visual display output 750, in accordance with one embodiment of the present invention. Visual display output 750 may include the same features as depicted in FIG. 6 with the following exceptions. Resulting information display area 730 on the touch sensitive screen of wearable-computing device 710 may include one or more interaction options displayed as a list or group of icons 755 that may be presented in ranked fashion 740. In an alternative embodiment, the list or group of icons may be presented in unranked fashion.

In one embodiment, the list or group of icons 755 are adapted to provide the user a way to request from the system particular secondary information related to the selected relevant advertisement by way of the user selecting one of the one or more interaction options in list or group of icons 755. The system may then transmit the user requested secondary information associated with the selected one of the one or more interaction options to second wearable-computing device 710.

In various embodiments, the one or more interaction options may include a request for additional information, to transmit a rating for the environmental signal, to connect in real-time to the advertiser (such as with a phone-call or video-call), to request email information, to be signed up for a “mailing list” of further information, to select to “like”, or may select to join the relevant Facebook page or twitter or other similar social media mechanism related to that advertisement or activity venue, and/or to be directed or receive navigation information to the merchant associated with the selected advertisement or where that merchant's product can be purchased or viewed, and the like.

In one embodiment, the one or more interaction options may further include a request to enter into a transaction or potential transaction associated with the information associated with the environmental signal from the sensor associated with wearable computing device 410. In an alternative embodiment, the environmental signal may be from a sensor associated with a wearable-computing device 710 depicted in FIG. 7. Accordingly, the information displayed on the portable computing device may be synchronized to any objects, signs, billboard, audio signals, audio ads, ultrasonic information, portable computing device advertisements, laptop ads, desktop ads, magazine ads, LED billboard ads, or any other online or offline advertisements or information sensed as the environmental signal. Further, such synchronization may be passively accomplished by the system by automatically monitoring and/or acting on the environmental signals in real time or upon demand by user selection. In various embodiments, the environmental signal may be associated with an advertisement, a venue for an activity, a location of the portable computing device, an orientation of the portable-computing device (e.g., the orientation being associated with a field of view of the user), and/or a movement of the portable computing device.

For example, related to the previously selected icon for the car rental company advertisement 670, list or group of icons 755 may include icons for the user to request, a display of a map to the nearest office, information for renting a car, a view of current redemption points, rating the environmental signal, which is the advertisement in this example, and returning back to the previous display screen. In one embodiment the list or group of icons 755 may be presented in rank order. For example the location of the portable computing device may be determined to be at an airport, determined with high confidence by correlated sensor data received by the portable computing device and transmitted in real time to the system. The system correlates the user's selection of the car rental advertisement with the airport location and previous use of that car rental agency to automatically determine that displaying a map to the nearest selected car rental office has highest rank value, renting the car second highest rank value, and so on.

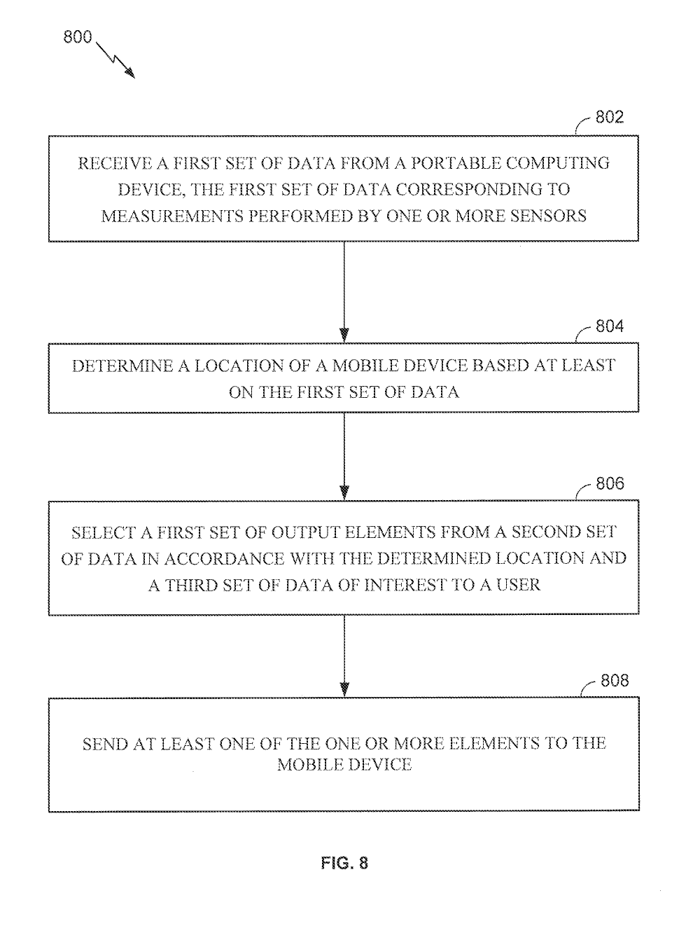

FIG. 8 shows exemplary operations that may be performed by a server for selecting advertisement information, according to one embodiment. At 802, the server receives a first set of data from a portable computing device. In one embodiment, the first set of data corresponds to measurements performed by one or more sensors. In one embodiment, the first set of data includes speed of movement of the portable computing device, direction of movement of the portable computing device, and/or angle of view of an advertising device from the portable computing device.

At 804, the server determines a location of a portable computing device based at least on the first set of data. At 806, the server selects a first set of output elements from a second set of data in accordance with the determined location and a third set of data of interest to a user. At 808, the server sends at least one of the one or more elements to the portable computing device.

In one embodiment, the server ranks the first set of output elements to generate a ranked set of data. The server may then send one or more of highest ranked elements of the ranked set of data to the portable computing device. In one embodiment, the server may rank the first set of output elements according to various criteria. The first set of output elements may include list of a viewer's soon-to-be seen, currently seen, or recently seen advertisement list. The criteria for ranking the output elements may include an advertiser's fee rate, time since a user of the portable computing device was impacted/impressed by an advertisement, relevancy of an advertisement to user's predicted or historical interests, and/or any other criteria.

In one embodiment, the server obtains information corresponding to locations of one or more advertising devices. For example, the server obtains information corresponding to static location of one or more billboards and/or static advertisements. In addition, the server may obtain information about real-time location of moving advertising devices (e.g., on cars, busses and the like) by frequently receiving information corresponding to location of these advertising devices.

In one embodiment, the first set of output elements are selected based on a distance between the location of the portable computing device and at least one of the one or more advertising devices. For example, if the portable computing device is located in vicinity of an advertising device, and/or is heading towards an advertising device and soon will be located in its vicinity, the advertising device (and/or its associated advertisement may receive a higher rank.

In one embodiment, the server receives information corresponding to locations of the one or more advertising devices from those devices. In another embodiment, the server retrieves the information corresponding to locations of one or more advertising devices from a database.

In one embodiment, the server estimates an upcoming (e.g., future) location of at least one of the advertising devices. In addition, the server estimates an upcoming location of the portable computing device based at least on the first set of data. The server may then select the first set of output elements based at least on the upcoming location of the at least one of the advertising devices and the upcoming location of the portable computing device.

In one embodiment, the server receives information corresponding to a global positioning system (GPS) from the portable computing device and one or more of the advertising devices, information corresponding to speed and direction of movement of the advertising devices.

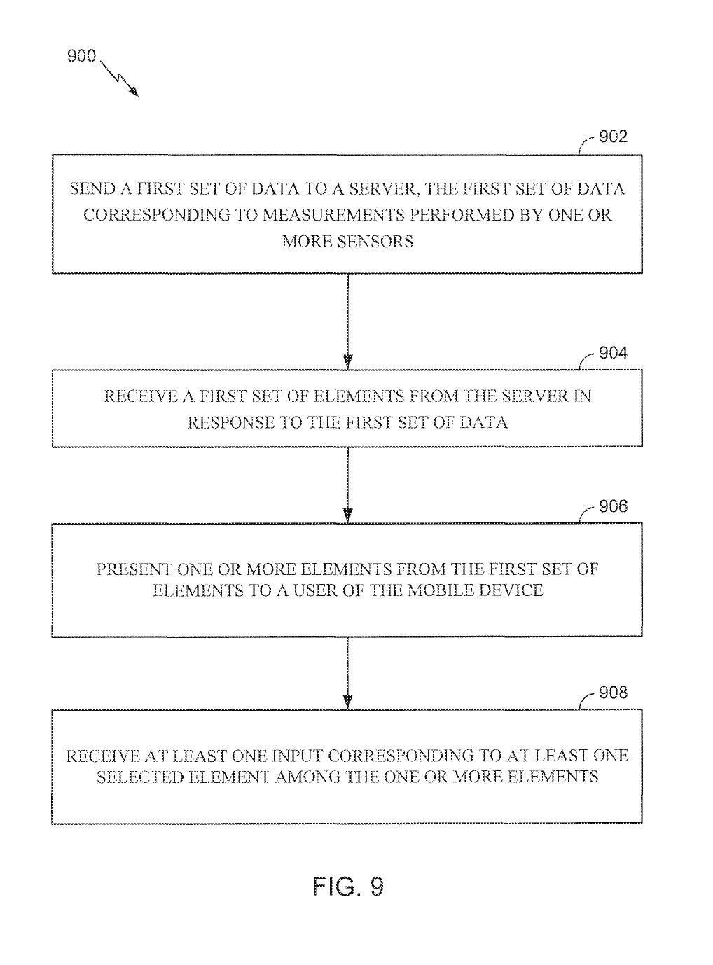

FIG. 9 shows exemplary operations that may be performed by a portable computing device for responding to advertisement information, according to one embodiment of the present invention. At 902, the portable computing device sends a first set of data to a server. The first set of data corresponds to measurements performed by one or more sensors. At 904, the portable computing device receives a first set of elements from the server in response to the first set of data. The first set of elements is ranked according to a relevance to a user of the portable computing device. For example, the first set of elements is ranked in accordance with a third set of data of interest to the user. At 906, the portable computing device presents one or more elements from the first set of elements to a user of the portable computing device. In addition, the portable computing device may present one or more options corresponding to the one or more elements to be selected by the user. At 908, the portable computing device receives at least one input corresponding to at least one selected element among the one or more elements.

In one embodiment, the user collects a second set of data of interest to a user, and sends the collected data to the server. In one embodiment, the portable computing device selects the one or more elements from the first set of elements based on one or more criteria. For example, the portable computing device selects one or more elements to be presented to the user based on time of day, screen size, and one or more user interests.

In one embodiment, the at least one input corresponds to a at least one further action to be taken by the portable computing device, such as requesting additional information corresponding to the selected element, requesting navigational information to a store corresponding to the advertiser, and the like.

In one embodiment, the portable computing device synchronizes its display with a display of an advertising device corresponding to one of the one or more elements.

In one embodiment, the portable computing device detects one or more advertising devices using one or more sensors; and displays information corresponding to the detected advertising device.

In one embodiment, the one or more sensors comprise one or more of optical sensors, infrared sensors, wireless communications signal detectors and/or any other type of environmental sensors.

In one embodiment, the portable computing device presents each of the one or more elements from the first set of elements during a time frame in which the portable computing device is in proximity of an area corresponding to the element. For example, the area corresponding to the element comprises an area in vicinity of an advertising device, e.g., within a predefined distance from the advertising device. In one embodiment, the area corresponding to the element includes an area corresponding to an event associated with the element.

In one embodiment, the portable computing device sends the one or more elements to a second device associated with the portable computing device (e.g., a wearable device). The second device may then present the one or more elements to a user.

In one embodiment, the portable computing device stores at least one of the one or more elements in a database for future use. For example, the portable computing device stores a list of recently seen, previously seen advertisements, advertisements for which the user requested additional information, and the like in one or more databases.

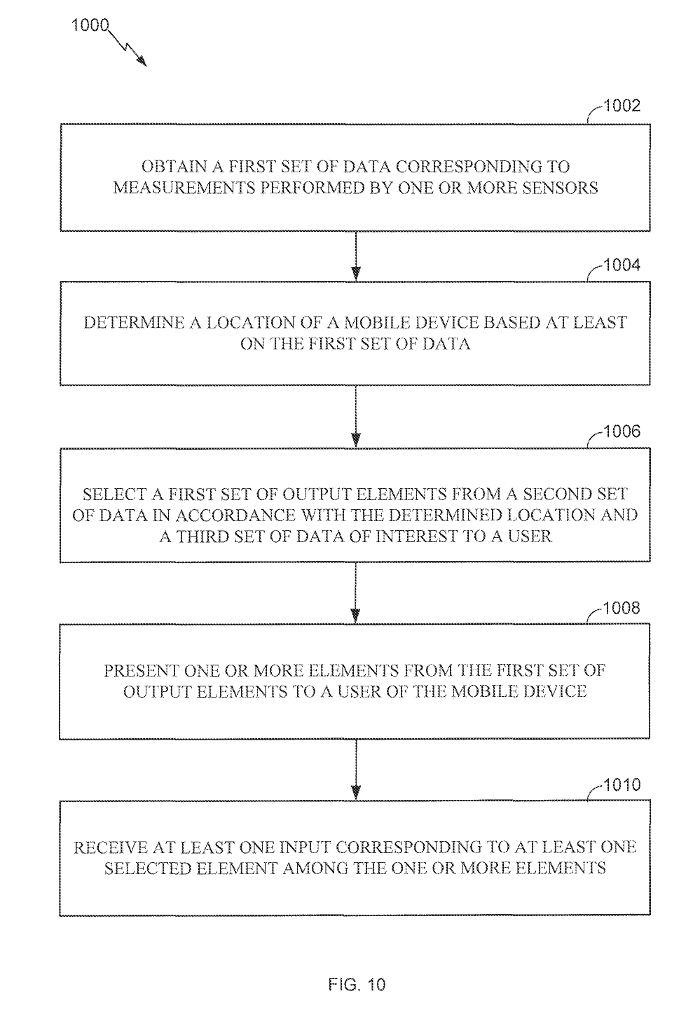

FIG. 10 shows another exemplary operations that may be performed by a portable computing device, as shown in FIG. 1, according to one embodiment of the present invention. At 1002, the portable computing device obtains a first set of data corresponding to measurements performed by one or more sensors. At 1004, the portable computing device determines a location of a portable computing device based at least on the first set of data. At 1006, the portable computing device selects a first set of output elements from a second set of data in accordance with the determined location and a third set of data of interest to a user. At 1008, the portable computing device presents one or more elements from the first set of output elements to a user of the portable computing device. At 1010, the portable computing device receives at least one input corresponding to at least one selected element among the one or more elements.

In one embodiment, the user (e.g., and associated portable computing device) receives incentives such as redemption points, miles, dollars, contest entrances, discounts, additional discounts, free items, additional items, virtual goods, portions of virtual goods, songs, music, games, apps, videos, and/or the like, and similar such virtual or non-virtual items, for reacting/responding to at least one interactive option.

In one embodiment, data relevance engine (150 as illustrated in FIG. 3) categorizes the incoming real-time events data and/or advertiser information using a data categorizing method, such as Bayesian classifier. The Bayesian classifier uses probabilistic statistical techniques to minimize the probability of misclassification by using training data to learn over time how to classify the incoming real-time events data and advertiser information correctly. In one embodiment, the categorization of the multitude of incoming real-time events data and advertiser information is used to create a multitude of information display types, such as sports scores, local information such as movie times, local merchant sales information, and the like. In one embodiment, the multitude of information display types may be presented to the user in either different locations within a display, or are rotated/presented to the user over time, e.g., audio streamed in user interest ranking order.

Data relevance engine 150 also receives sensor data, e.g., audio, video, location, time, and device information associated with blocks 315, 320, 325, and 330 in FIG. 3, respectively. In one embodiment, the sensor's data may be assigned a numerical weighting with the purpose of giving that sensor's data a relative importance. The numerical weight assigned to any given data input is referred to as the RankWeight for that sensor type. This ranking is not the only algorithm that determines rankings in the output results, but merely one of many factors used to determine ranking of input data at any given time. The RankWeight may be static or dynamic, and may be different for different types of sensors, users, or corresponding to other factors. In one embodiment, more recent primary sensor data, such as voice-recognized words may be given a higher weight (e.g., more relevant) than older data.

The received sensor data and the classified real-time events data and advertiser information are used to select relevant advertisement or data. In one embodiment, the information may be ranked by a weighted sum approach, Eigen-vector approach, or any other approach and/or algorithm. In one embodiment, collaborative filtering may be used to automatically estimate the relevance for the data. For example, data may be assigned a predicted weight factor (e.g., by filtering) based on matching a multitude of recommendations, e.g., collaboration, from social media friends for data that the user of the portable-computing device has not directly rated. Collaborative filtering leverages the extensive data input from social media and the other extensive secondary data sources that are input to the data relevance engine with high statistical confidence.

Several exemplary formulas are presented below to demonstrate how to calculate weighted averages which serves as an element in calculating a relevance of data. The weighted mean is similar to an arithmetic mean, e.g., the most common type of average, where instead of each of the data points contributing equally to the final average, some data points contribute more than other data points. The notion of weighted mean plays a role in descriptive statistics and also occurs in a more general form in several other areas of mathematics.

Formally, a weighted mean of a non-empty set of data {x₁, x₂, . . . , xₙ}, with non-negative weights {w₁, w₂, . . . , wₙ}, can be written as follows:

$$\overline{x} = \frac{{\sum }_{i = 1}^{n} {w}_{i} {x}_{i}}{{\sum }_{j = 1}^{n} {w}_{i}} , or \overline{x} = \frac{{w}_{1} {x}_{1} + {w}_{2} {x}_{2} + … + {w}_{n} {x}_{n}}{{w}_{1} + {w}_{2} + … + {w}_{n}} .$$

Therefore, data elements with a high weight contribute more to the weighted mean than do elements with a low weight. The weights cannot be negative. Some may be zero, but not all of them (since division by zero is not allowed).

The formulas are simplified when the weights are normalized such that they sum up to one (e.g., Σ_{1,i.e.i=1}ⁿ wᵢ=1). For such normalized weights, the weighted mean can be written as follows:

$$\overline{x} = {\sum }_{i = 1}^{n} {w}_{i} {x}_{i}$$

Note that one may normalize the weights by making a transformation on the weights such that

$${w}_{i}^{′} = \frac{{w}_{i}}{{\sum }_{j = 1}^{n} {w}_{j}} .$$

Using the normalized weights yields the same results as when using the original weights. Indeed,

$$\overline{x} = {\sum }_{i = 1}^{n} {w}_{i}^{′} {x}_{i} = {\sum }_{i = 1}^{n} \frac{{w}_{i}}{{\sum }_{j = 1}^{n} {w}_{j}} {x}_{i} = \frac{{\sum }_{i = 1}^{n} {w}_{i} {x}_{i}}{{\sum }_{j = 1}^{n} {w}_{j}} = \frac{{\sum }_{i = 1}^{n} {w}_{i} {x}_{i}}{{\sum }_{i = 1}^{n} {w}_{i}} .$$

The common mean

$$\frac{1}{n} {\sum }_{i = 1}^{n} {x}_{i}$$

is a special case of the weighted mean where all data have equal weights, wᵢ=w. When the weights are normalized, then

$${w}_{i}^{′} = \frac{1}{n} .$$

To take into account variance, the weighted mean of a list of data for which each element xᵢ comes from a different probability distribution with known variance σᵢ², one possible choice for the weights may be written as follows:

$${w}_{i} = \frac{1}{{σ}_{i}^{2}} .$$

The weighted mean may then be written as follows:

$$\overline{x} = \frac{{\sum }_{i = 1}^{n} ( {x}_{i} {w}_{i} )}{{\sum }_{i = 1}^{n} {w}_{i}} ,$$

and the variance of the weighted mean may be written as follows:

$${σ}_{\overline{x}}^{2} = \frac{1}{{\sum }_{i = 1}^{n} {w}_{i}} ,$$

which reduces to

$${σ}_{\overline{x}}^{2} = \frac{{σ}_{0}^{2}}{n} ,$$

when all σᵢ=σ₀.

The significance of this choice is that this weighted mean is the maximum likelihood estimator of the mean of the probability distributions under the assumption that they are independent and normally distributed with the same mean.

### Vector-Valued Estimates:

As in the scalar case, the weighted mean of multiple estimates can provide a maximum likelihood estimate. For vector-valued estimates, σ² may be replaced by the covariance matrix, as follows:

Wᵢ=Σᵢ⁻¹.

The weighted mean may be written as follows:

$$\overline{x} = {( {\sum }_{i = 1}^{n} {\sum }_{i}^{- 1} )}^{- 1} ( {\sum }_{i = 1}^{n} {\sum }_{i}^{- 1} {x}_{i} ) ,$$

and the covariance of the weighted mean may be written as follows:

$${\sum }_{\overline{x}} = {( {\sum }_{j = 1}^{n} {\sum }_{i}^{- 1} )}^{- 1} ,$$

For example, consider the weighted mean of the point [1 0] with high variance in the second component and [0 1] with high variance in the first component. Then

$${x}_{1} = {[ 10 ]}^{⊤} , {\sum }_{1} = [ \begin{matrix}1 & 0 \\ 0 & 100\end{matrix} ]$$

$${x}_{2} = {[ 01 ]}^{⊤} , {\sum }_{2} = [ \begin{matrix}100 & 0 \\ 0 & 1\end{matrix} ] ,$$

Then, the weighted mean may be written as follows:

$$\begin{matrix}\overline{x} = {( {\sum }_{1}^{- 1} + {\sum }_{2}^{- 1} )}^{- 1} ( {\sum }_{1}^{- 1} {x}_{1} + {\sum }_{2}^{- 1} {x}_{2} ) \\ = [ \begin{matrix}0.9901 & 0 \\ 0 & 0.9901\end{matrix} ] [ \begin{matrix}1 \\ 1\end{matrix} ] \\ = [ \begin{matrix}0.9901 \\ 0.9901\end{matrix} ] ,\end{matrix}$$

in this case, the [1 0] estimate is “compliant” in the second component and the [0 1] estimate is compliant in the first component, so the weighted mean is nearly [1 1].

Another method of calculation takes into account correlations between data elements. In the general case, suppose that X=[x₁, . . . , xₙ], C is the covariance matrix relating the quantities xᵢ, x̅ is the common mean to be estimated, and W is the design matrix [1, . . . , 1] (of length n). The Gauss-Markov theorem states that the estimate of the mean having minimum variance is written as follows:

σ _{x̅}²=(W^{T}C⁻¹W)⁻¹,

and

x̅=σ _{x̅}²=(W^{T}C⁻¹X).

Consider the time series of an independent variable x and a dependent variable y, with n observations sampled at discrete times tᵢ. In many common situations, the value of y at time tᵢ depends not only on xᵢ but also on its past values. Commonly, the strength of this dependence decreases as the separation of observations in time increases. To model this situation, one may replace the independent variable by its sliding mean z for a window size m, as follows:

$${z}_{k} {\sum }_{i = 1}^{m} {w}_{i} {x}_{k + 1 - i} ,$$

In the scenario described in the previous section, most frequently the decrease in interaction strength obeys a negative exponential law. If the observations are sampled at equidistant times, then exponential decrease is equivalent to decrease by a constant fraction 0<Δ<1 at each time step. Setting w=1=Δ, m normalized weights can be defined as follows:

$${w}_{i} = \frac{{w}^{i - 1}}{{V}_{1}} ,$$

where V₁ is the sum of the un-normalized weights. In this case V₁ can be written as follows:

$${V}_{1} = {\sum }_{i = 1}^{m} {w}^{i - 1} = \frac{1 - {w}^{m}}{1 - w} ,$$

In this case, V₁ approaches V₁=1/(1−w) for large values of m.

The damping constant w corresponds to the actual decrease of interaction strength. If this cannot be determined from theoretical considerations, then the following properties of exponentially decreasing weights are useful in making a suitable choice: at step (1−w)⁻¹, the weight approximately equals to e⁻¹(1−w)=0.39(1−w), the tail area approximately equals to e⁻¹, the head area approximately equals to 1−e⁻¹=0.61. The tail area at step n is ≦e^{-n(1-w)}, where primarily the closest n observations matter and the effect of the remaining observations can be ignored safely. Then the damping constant w may be chosen such that the tail area is sufficiently small. It should be noted that the weight calculation methods described above are mere examples, and any other weight calculating and/or ranking method may be used without departing from the teachings of the present disclosure.

In one embodiment, the user may provide active feedback via the portable-computing device. Active feedback may include explicit user feedback, e.g., thumbs-up or thumbs-down, and/or selecting an option among presented interactive options. Active feedback may further include implicit user feedback based for example on the user purchasing an advertised product or service. An example of implicit user feedback may be when a user buys the product or service or visits a vendor or service venue. User feedback may be stored in a user interest database. User interest data may further include historical information, which may be heavily weighted to prefer recent data. Historical information may include prior purchases, location destinations, and the like. In one embodiment, a user's feedback or selections are used to modify/change the weightings of that user's later displayed resulting information. In one embodiment, relevance outputs can be weighted by a user's stated, e.g., explicit user feedback, or detected, e.g., implicit user feedback interests. For example, twitter #hashtags, Facebook Likes, recent social media or email data, a user's friend's Facebook postings, and the like.

In one embodiment, when the primary sensor information is continuously transmitted, the data relevance engine may continuously and/or passively monitor (e.g., “listen”), decode using voice recognition, and correlate words or phrases in conversation within hearing distance of the portable-computing device, to provide real-time user interest information associated with those “heard” words. For example, if the microphone input of the portable-computing device hears the word “hungry,” the data relevance engine may automatically display a distance to a restaurant that serves food that is of interest to the user. In another embodiment, when the primary sensor information is continuously transmitted, the data relevance engine may continuously and/or passively monitor, decode and correlate captured video or periodically sampled static visual images in the line-of-sight of the portable-computing device, to provide real time user interest information. In one embodiment, the decoded video or camera image data may include decoded text key words or symbols associated with advertising.

In one embodiment, data such as #hashtags associated with a user's interests, or in another example a list of “likes” associated with a user's interests, are used to correlate and weight data inputs. For example, if a user's wearable-computing-device recognizes (e.g., passively or actively) the words “Italian,” then one such resulting output streams may be Italian restaurants in the local area.

In one embodiment, the weighting of the data may be influenced by other relevant people's prior selections. Other relevant people may include people other than the user who may be nearby, friends, or anyone else. Such ranking may be further ranked according to the other relevant person's “distance,” e.g., geographic distance, social graph distance, and/or the like, from the user. In one embodiment, tweets, Facebook posts, and other social media or blog or related posts (entries) are used as inputs into the data relevance engine

In one embodiment, the resulting information may not necessarily be displayed or immediately displayed on the same device. A first portion of the multitude of resulting information may be displayed on a portable-computing device, while a second portion different than the first portion may be displayed on another portable-computing device.

In one embodiment, pictures and any resulting text or extracted data, e.g., facial recognition/identification of people captured by the sensors on the user's portable-computing device may be used as primary inputs into the real-time relevance engine. In one embodiment, data from the sensors on the user's portable-computing device are combined and/or correlated with sensor input data from other nearby sensors to increase the confidence of the rank weighting of that sensor's data. Other nearby sensors may include sensors corresponding to other users, or any other fixed sensor that are in close proximity to the user. This combined/correlated sensor data may both increase the confidence of the sensor input when two different nearby sensors are sensing the same inputs, or could decrease the confidence when two nearby sensors are detecting different information.

In one embodiment, an intention detection output from the data relevance engine may be calculated based on a weighted input of factors including; a) real time location sensor data, e.g., what shopping district the portable-computing device and user are in, b) place of business, e.g., what specific store the portable-computing device is in, and c) detected items, e.g., what product packaging the portable-computing device is seeing in real time. In one embodiment, real-time analytics are output from the data relevance engine. Such analytics and/or “intention detection” outputs may be used to improve relevant advertisement selection.

In one embodiment, the multitude of sensor and non-sensor inputs are cross-correlated to confirm real-time relevance, e.g., improving signal to noise ratio. For example, an audio input, e.g., when the phrase “all passengers to gate 70” is registered by the data-relevance engine then user's portable-computer device is likely at an airport, may be correlated with a GPS location input, which also indicates the user's portable-computer device is at an airport, then relevancy to an airport location is further confirmed. In one embodiment, further data may be inferred from other sensor data. For example, a real-time speed may be inferred from the GPS location sensor data. In one embodiment, sensor data, e.g., audio inputs and resulting voice recognition words, associated with a GPS location may be stored and correlated with that GPS location as historical data, such that when another or future user's portable-computer device may be at that same location in the future, then the prior audio input voice recognized words may be used for further relevance inputs or weighting. Such historical data may be discounted by time, e.g., age of the historical data.

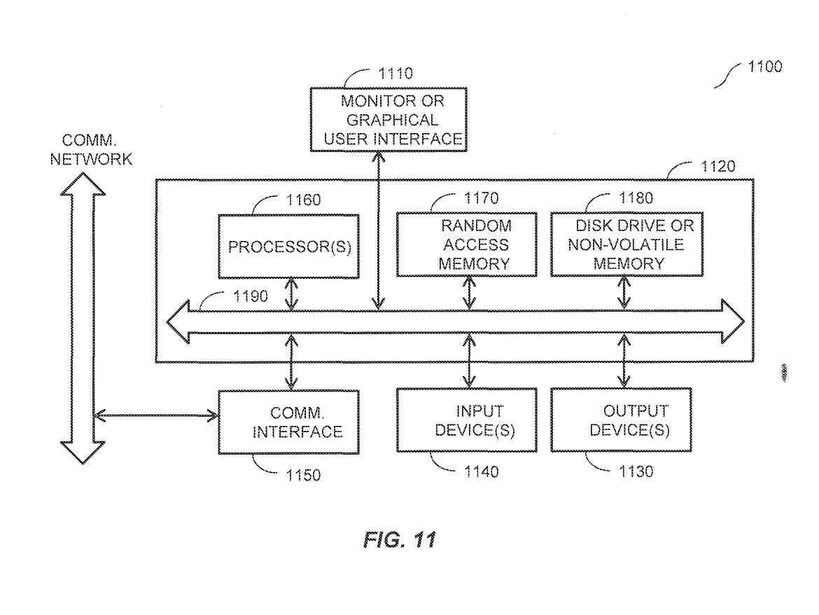

FIG. 11 shows a simplified block diagram of a computer system that may incorporate embodiments of the present invention. FIG. 11 is merely illustrative of an embodiment incorporating the present invention and does not limit the scope of the invention as recited in the claims. One of ordinary skill in the art would recognize other variations, modifications, and alternatives.

In one embodiment, computer system 1100 typically includes a monitor or 1110, a computer 1120, user output devices 1130, user input devices 1140, communications interface 1150, and the like. Computer system 1100 may also be a smart phone, tablet-computing device, and the like, such that the boundary of computer 1120 may enclose monitor or graphical user interface 1110, user output devices 1130, user input devices 1140, and/or communications interface 1150 (not shown).

As shown in FIG. 11, computer 1120 may include a processor(s) 1160 that communicates with a number of peripheral devices via a bus subsystem 1190. These peripheral devices may include user output devices 1130, user input devices 1140, communications interface 1150, and a storage subsystem, such as random access memory (RAM) 1170 and disk drive or non-volatile memory 1180.

User input devices 1130 include all possible types of devices and mechanisms for inputting information to computer system 1120. These may include a keyboard, a keypad, a touch screen incorporated into the display, audio input devices such as voice recognition systems, microphones, and other types of input devices. In various embodiments, user input devices 1130 are typically embodied as a computer mouse, a trackball, a track pad, a joystick, wireless remote, drawing tablet, voice command system, eye tracking system, and the like. User input devices 1130 typically allow a user to select objects, icons, text and the like that appear on the monitor or graphical user interface 1110 via a command such as a click of a button, touch of the display screen, or the like.

User output devices 1140 include all possible types of devices and mechanisms for outputting information from computer 1120. These may include a display (e.g., monitor or graphical user interface 1110), non-visual displays such as audio output devices, etc.

Communications interface 1150 provides an interface to other communication networks and devices. Communications interface 1150 may serve as an interface for receiving data from and transmitting data to other systems. Embodiments of communications interface 1150 typically include an Ethernet card, a modem (telephone, satellite, cable, ISDN), (asynchronous) digital subscriber line (DSL) unit, FireWire interface, USB interface, and the like. For example, communications interface 1150 may be coupled to a computer network, to a FireWire bus, or the like. In other embodiments, communications interfaces 1150 may be physically integrated on the motherboard of computer 1120, and may be a software program, such as soft DSL, or the like. Embodiments of communications interface 1150 may also include a wireless radio transceiver using radio transmission protocols such as Bluetooth®, WiFi®, cellular, and the like.

In various embodiments, computer system 1100 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 1120 includes one or more Xeon microprocessors from Intel as processor(s) 1160. Further, one embodiment, computer 1120 includes a UNIX-based operating system. In another embodiment, the processor may be included in an applications processor or part of a system on a chip.

RAM 1170 and disk drive or non-volatile memory 1180 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 1170 and disk drive or non-volatile memory 1180 may be configured to store the basic programming and data constructs that provide the functionality of the present invention.

Software code modules and instructions that provide the functionality of the present invention may be stored in RAM 1170 and disk drive or non-volatile memory 1180. These software modules may be executed by processor(s) 1160. RAM 1170 and disk drive or non-volatile memory 1180 may also provide a repository for storing data used in accordance with the present invention.

RAM 1170 and disk drive or non-volatile memory 1180 may include a number of memories including a main random access memory (RAM) for storage of instructions and data during program execution and a read only memory (ROM) in which fixed instructions are stored. RAM 1170 and disk drive or non-volatile memory 1180 may include a file storage subsystem providing persistent (non-volatile) storage for program and data files. RAM 1170 and disk drive or non-volatile memory 1180 may also include removable storage systems, such as removable flash memory.

Bus subsystem 1190 provides a mechanism for letting the various components and subsystems of computer 1120 communicate with each other as intended. Although bus subsystem 1190 is shown schematically as a single bus, alternative embodiments of the bus subsystem may utilize multiple busses.

FIG. 11 is representative of a computer system capable of embodying a portion of the present invention. It will be readily apparent to one of ordinary skill in the art that many other hardware and software configurations are suitable for use with the present invention. For example, the computer may be a desktop, laptop, portable, rack-mounted, smart phone or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; embedded processors such as ARM® licensed from ARM® Holdings plc., and the like. Further, other types of operating systems are contemplated, such as Windows®, WindowsXP®, WindowsNT®, WindowsRT® or the like from Microsoft Corporation, Solaris from Sun Microsystems, LINUX, UNIX, or mobile operating systems such as Android® from Google Inc., iOS® from Apple Inc., Symbion® from Nokia Corp., and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The above embodiments of the present invention are illustrative and not limiting. The above embodiments of the present invention may be combined, in one or multiple combinations, as various alternatives and equivalents are possible. Although, the invention has been described with reference to a wearable-computing device such as a smart-watch by way of an example, it is understood that the invention is not limited by the type of wearable device. Although, the invention has been described with reference to certain radio communications interface by way of an example, it is understood that the invention is not limited by the type of radio, wireless, or wired communications interface. Although, the invention has been described with reference to certain operating systems by way of an example, it is understood that the invention is not limited by the type of operating systems. Other additions, subtractions, or modifications are obvious in view of the present disclosure and are intended to fall within the scope of the appended claims.

What is claimed is:

1. A method for selecting advertisement information, comprising:
receiving a first set of data from a portable computing device, the first set of data corresponding to measurements performed by one or more sensors;
determining a location of a portable computing device based at least on the first set of data;
selecting a first set of output elements from a second set of data in accordance with the determined location and a third set of data of interest to a user;
sending at least one of the one or more elements to the portable computing device.

2. The method of claim 1, further comprising:
ranking the first set of output elements to generate a ranked set of data;
and wherein sending at least one of the first set of output elements comprises sending one or more of highest ranked elements of the ranked set of data to the portable computing device.

3. The method of claim 2, further comprising ranking the first set of output elements based on one or more of an advertiser's fee rate, time since a user of the portable computing device was impacted by an advertisement, relevancy of an advertisement to interest of the user of the portable computing device.

4. The method of claim 1, further comprising:
obtaining information corresponding to locations of one or more advertising devices.

5. The method of claim 4, wherein selecting the first set of output elements further comprises selecting the first set of output elements based on a distance between the location of the portable computing device and at least one of the one or more advertising devices.

6. The method of claim 4, wherein obtaining information corresponding to locations of one or more advertising devices comprises:
retrieving the information corresponding to locations of one or more advertising devices from a database.

7. The method of claim 4, wherein obtaining information corresponding to locations of one or more advertising devices comprises:
receiving the information corresponding to locations of the one or more advertising devices.

8. The method of claim 4, further comprising:
estimating an upcoming location of at least one of the advertising devices;
estimating an upcoming location of the portable computing device based at least on the first set of data; and
wherein selecting the first set of output elements further comprises selecting the first set of output elements based at least on the upcoming location of the at least one of the advertising devices and the upcoming location of the portable computing device.

9. The method of claim 8, wherein estimating the upcoming location of at least one of the advertising devices comprises:
estimating the upcoming location of the at least one of the advertising devices based at least on information corresponding to a global positioning system (GPS).

10. The method of claim 1, wherein the first set of data further comprises at least one of a speed of movement of the portable computing device, direction of movement of the portable computing device, and angle of view of an advertising device from the portable computing device.

11. The method of claim 1, wherein the first set of output elements comprises information corresponding to one or more of recently-seen advertisement devices, one or more soon-to be seen advertisement devices, and one or more currently seen advertisement devices.

12. A method for responding to advertisement information, comprising:
sending, from a portable computing device, a first set of data to a server, the first set of data corresponding to measurements performed by one or more sensors;
receiving a first set of elements from the server in response to the first set of data;
presenting one or more elements from the first set of elements to a user of the portable computing device; and
receiving at least one input corresponding to at least one selected element among the one or more elements.

13. The method of claim 12, further comprising:
sending, to the server, a second set of data of interest to a user.

14. The method of claim 12, further comprising:
selecting the one or more elements from the first set of elements based on one or more criteria.

15. The method of claim 12, wherein the at least one input corresponds to at least one further action to be taken by the portable computing device.

16. The method of claim 15, wherein the at least one action comprises requesting additional information corresponding to the selected element.

17. The method of claim 15, wherein the at least one action comprises requesting navigational information to a store corresponding to the advertiser.

18. The method of claim 12, wherein presenting the one or more elements from the first set of elements further comprises:
synchronizing a display of the portable computing device with a display of an advertising device corresponding to one of the one or more elements.

19. The method of claim 12, further comprising:
detecting one or more advertising devices using one or more sensors; and
displaying information corresponding to the detected advertising device.

20. The method of claim 19, wherein the one or more sensors comprise one or more of optical sensors, infra-red sensors, wireless communications signal detector.

21. The method of claim 12, wherein presenting the one or more elements from the first set of elements further comprises:
presenting each of the one or more elements from the first set of elements during a time frame in which the portable computing device is in proximity of an area corresponding to the element.

22. The method of claim 21, wherein the area corresponding to the element comprises an area in vicinity of an advertising device.

23. The method of claim 21, wherein the area corresponding to the element comprises an area corresponding to an event associated with the element.

24. The method of claim 21, wherein presenting the one or more elements from the first set of elements further comprises:
presenting one or more options corresponding to the one or more elements to be selected by a user.

25. The method of claim 12, wherein the first set of elements are ranked according to a relevance to a user of the portable computing device.

26. The method of claim 12, wherein presenting one or more elements from the first set of elements comprises:
sending the one or more elements to a second device associated with the portable computing device, and
presenting the one or more elements on the second device.

27. The method of claim 12, further comprising:
presenting an incentive to the user upon receiving the at least one input.

28. The method of claim 12, further comprising:
storing at least one of the one or more elements in a database.

29. A method for responding to advertisement information, comprising:
obtaining a first set of data corresponding to measurements performed by one or more sensors;
determining a location of a portable computing device based at least on the first set of data;
selecting a first set of output elements from a second set of data in accordance with the determined location and a third set of data of interest to a user;
presenting one or more elements from the first set of elements to a user of the portable computing device; and
receiving at least one input corresponding to at least one selected element among the one or more elements.

30. The method of claim 29, further comprising:
ranking the one or more elements in accordance with a third set of data of interest to the user of the portable computing device, and presenting the ranked elements.

31. The method of claim 29, further comprising:
ranking the first set of elements to generate a ranked set of data;
and wherein presenting one or more elements from the first set of elements comprises presenting one or more of highest ranked elements of the ranked set of data.

32. The method of claim 31, wherein ranking the first set of elements comprises ranking the first set of output elements based on one or more of an advertiser's fee rate, time since a user of the portable computing device was impacted by an advertisement, relevancy of an advertisement to interest of the user of the portable computing device.

33. The method of claim 29, further comprising:
obtaining information corresponding to locations of one or more advertising devices.

34. An apparatus for selecting advertisement information, comprising:
a memory; and
at least one processor coupled to the memory, the at least one processor configured to:
receive a first set of data from a portable computing device, the first set of data corresponding to measurements performed by one or more sensors;
determine a location of a portable computing device based at least on the first set of data;
select a first set of output elements from a second set of data in accordance with the determined location and a third set of data of interest to a user;
send at least one of the one or more elements to the portable computing device.

35. The apparatus of claim 34, wherein the at least one processor is further configured to:
rank the first set of output elements to generate a ranked set of data; and
send one or more of highest ranked elements of the ranked set of data to the portable computing device.

36. The apparatus of claim 35, wherein the at least one processor is further configured to rank the first set of output elements based on one or more of an advertiser's fee rate, time since a user of the portable computing device was impacted by an advertisement, relevancy of an advertisement to interest of the user of the portable computing device.

37. The apparatus of claim 34, wherein the at least one processor is further configured to obtain information corresponding to locations of one or more advertising devices.

38. The apparatus of claim 37, wherein the at least one processor is further configured to select the first set of output elements based on a distance between the location of the portable computing device and at least one of the one or more advertising devices.

39. The apparatus of claim 37, wherein the at least one processor is further configured to retrieve the information corresponding to locations of one or more advertising devices from a database.

40. The apparatus of claim 37, wherein the at least one processor is further configured to receive the information corresponding to locations of the one or more advertising devices.

41. The apparatus of claim 37, wherein the at least one processor is further configured to:
estimate an upcoming location of at least one of the advertising devices;
estimate an upcoming location of the portable computing device based at least on the first set of data; and
select the first set of output elements based at least on the upcoming location of the at least one of the advertising devices and the upcoming location of the portable computing device.

42. The apparatus of claim 41, wherein the at least one processor is further configured to estimate the upcoming location of the at least one of the advertising devices based at least on information corresponding to a global positioning system (GPS).

43. The apparatus of claim 34, wherein the first set of data further comprises at least one of a speed of movement of the portable computing device, direction of movement of the portable computing device, and angle of view of an advertising device from the portable computing device.

44. The apparatus of claim 34, wherein the first set of output elements comprises information corresponding to one or more of recently-seen advertisement devices, one or more soon-to be seen advertisement devices, and one or more currently seen advertisement devices.

45. An apparatus for responding to advertisement information, comprising:
an output device;
a memory; and
at least one processor coupled to the memory and the output device, the at least one processor configured to:
send a first set of data to a server, the first set of data corresponding to measurements performed by one or more sensors,
receive a first set of elements from the server in response to the first set of data,
present one or more elements from the first set of elements to a user of the apparatus, and
receive at least one input corresponding to at least one selected element among the one or more elements.

46. The apparatus of claim 45, wherein the at least one processor is further configured to send a second set of data of interest to a user.

47. The apparatus of claim 45, wherein the at least one processor is further configured to select the one or more elements from the first set of elements based on one or more criteria.

48. The apparatus of claim 45, wherein the at least one processor is further configured to take at least one further action corresponding to the at least one input.

49. The apparatus of claim 48, at least one processor is further configured to request additional information corresponding to the selected element.

50. The apparatus of claim 48, at least one processor is further configured to request navigational information to a store corresponding to the advertiser.

51. The apparatus of claim 45, wherein the at least one processor is further configured to synchronize the output device of the apparatus with a display of an advertising device corresponding to one of the one or more elements.

52. The apparatus of claim 45, wherein the at least one processor is further configured to:
detect one or more advertising devices using one or more sensors; and
display information corresponding to the detected advertising device.

53. The apparatus of claim 52, wherein the one or more sensors comprise one or more of optical sensors, infra-red sensors, wireless communications signal detector.

54. The apparatus of claim 45, wherein the at least one processor is further configured to present each of the one or more elements from the first set of elements during a time frame in which the apparatus is in proximity of an area corresponding to the element.

55. The apparatus of claim 54, wherein the area corresponding to the element comprises an area in vicinity of an advertising device.

56. The apparatus of claim 54, wherein the area corresponding to the element comprises an area corresponding to an event associated with the element.

57. The apparatus of claim 54, wherein the at least one processor is further configured to present one or more options corresponding to the one or more elements to be selected by a user.

58. The apparatus of claim 45, wherein the first set of elements are ranked according to a relevance to a user of the apparatus.

59. The apparatus of claim 45, wherein the at least one processor is further configured to:
send the one or more elements to a second device associated with the apparatus, wherein the second device presents the one or more elements to the user.

60. The apparatus of claim 45, wherein the at least one processor is further configured to present an incentive to the user upon receiving the at least one input.

61. The apparatus of claim 45, wherein the at least one processor is further configured to store at least one of the one or more elements in a database.

62. An apparatus for responding to advertisement information, comprising:
an output device;
a memory;
at least one processor coupled to the memory and the output device, the at least one processor configured to:
obtain a first set of data corresponding to measurements performed by one or more sensors,
determine a location of the apparatus based at least on the first set of data,
select a first set of output elements from a second set of data in accordance with the determined location and a third set of data of interest to a user,
present one or more elements from the first set of elements to a user of the apparatus, and
receive at least one input corresponding to at least one selected element among the one or more elements.

63. The apparatus of claim 62, wherein the at least one processor is further configured to rank the one or more elements in accordance with a third set of data of interest to the user of the apparatus, and presenting the ranked elements.

64. The apparatus of claim 62, wherein the at least one processor is further configured to:
rank the first set of elements to generate a ranked set of data;
present one or more of highest ranked elements of the ranked set of data.

65. The apparatus of claim 64, wherein the at least one processor is further configured to rank the first set of output elements based on one or more of an advertiser's fee rate, time since a user of the apparatus was impacted by an advertisement, relevancy of an advertisement to interest of the user of the apparatus.

66. The apparatus of claim 62, wherein the at least one processor is further configured to obtain information corresponding to locations of one or more advertising devices.

67. A non-transitory computer-readable medium comprising computer readable instructions configured to cause a processor to:
receive a first set of data from a portable computing device, the first set of data corresponding to measurements performed by one or more sensors;
determine a location of a portable computing device based at least on the first set of data;
select a first set of output elements from a second set of data in accordance with the determined location and a third set of data of interest to a user;
send at least one of the one or more elements to the portable computing device.

68. A non-transitory computer-readable medium comprising computer readable instructions configured to cause a processor to:
send a first set of data to a server, the first set of data corresponding to measurements performed by one or more sensors;
receive a first set of elements from the server in response to the first set of data;
present one or more elements from the first set of elements to a user of the portable computing device; and
receive at least one input corresponding to at least one selected element among the one or more elements.

69. A non-transitory computer-readable medium comprising computer readable instructions configured to cause a processor to:
obtain a first set of data corresponding to measurements performed by one or more sensors;
determine a location of the portable computing device based at least on the first set of data,
select a first set of output elements from a second set of data in accordance with the determined location and a third set of data of interest to a user;
present one or more elements from the first set of elements to a user of the portable computing device; and
receive at least one input corresponding to at least one selected element among the one or more elements.
